(19) United States
(12) Patent Application Publication
(10) Pub. No.: US 2021/0075675 A1
(43) Pub. Date: Mar. 11, 2021

(54) ENHANCED NETWORK ARCHITECTURE IN WIRLESS COMMUNICATIONS

(71) Applicants: Dave Cavalcanti, Portland, OR (US); Juan Fang, Portland, OR (US); Jeffrey Foerster, Portland, OR (US); Mikhail Galeev, Beaverton, OR (US); Minyoung Park, San Ramon, CA (US); Mohammad Mamunur Rashid, Hillsboro, OR (US); Javier Perez-Ramirez, North Plains, OR (US); Laurent Cariou, Portland, OR (US); Carlos Cordeiro, Portland, OR (US)

(72) Inventors: Dave Cavalcanti, Portland, OR (US); Juan Fang, Portland, OR (US); Jeffrey Foerster, Portland, OR (US); Mikhail Galeev, Beaverton, OR (US); Minyoung Park, San Ramon, CA (US); Mohammad Mamunur Rashid, Hillsboro, OR (US); Javier Perez-Ramirez, North Plains, OR (US); Laurent Cariou, Portland, OR (US); Carlos Cordeiro, Portland, OR (US)

(21) Appl. No.: 17/083,220

(22) Filed: Oct. 28, 2020

Related U.S. Application Data
(60) Provisional application No. 62/926,636, filed on Oct. 28, 2019.
(60) Provisional application No. 62/926,652, filed on Oct. 28, 2019.

(51) Int. Cl. H04L 12/24; H04W 24/02

(52) U.S. Cl. CPC H04L 41/0823; H04W 84/12; H04W 24/02

(57) ABSTRACT

This disclosure describes systems, methods, and devices related to time-sensitive networking in wireless communications. A device may exchange time-sensitive networking (TSN) capabilities with one or more station devices associated with the device. The device may identify a TSN capability request received from a TSN management entity associated with a TSN domain. The device may transmit a TSN capability response to the TSN management entity. The device may identify a TSN capability configuration frame from the TSN management entity. The device may configure the TSN capabilities based on the TSN capability configuration frame.

### CROSS-REFERENCE TO RELATED APPLICATION(S)

This application claims the benefit of U.S. Provisional Application No. 62/926,636, filed Oct. 28, 2019, and U.S. Provisional Application No. 62/926,652, filed Oct. 28, 2019, the disclosures of which are incorporated herein by reference as if set forth in full.

### TECHNICAL FIELD

This disclosure generally relates to systems and methods for wireless communications and, more particularly, to time-sensitive networking in wireless communications.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1 is a network diagram illustrating an example network environment, in accordance with one or more example embodiments of the present disclosure.

FIG. 2 depicts an illustrative schematic diagram for IEEE 802.11Qcc Centralized TSN Management Model.

FIG. 3 depicts an illustrative schematic diagram for an example format of a TSN capability element, in accordance with one or more example embodiments of the present disclosure.

FIG. 4 depicts an illustrative schematic diagram for an example TSN capability information field, in accordance with one or more example embodiments of the present disclosure.

FIG. 5 depicts an illustrative schematic diagram for a time-sensitive setup, in accordance with one or more example embodiments of the present disclosure.

FIG. 6 depicts an illustrative schematic diagram for a time-sensitive information field, in accordance with one or more example embodiments of the present disclosure.

FIG. 7 depicts an illustrative schematic diagram for time-sensitive setup when initiated by an AP, in accordance with one or more example embodiments of the present disclosure.

FIG. 8 depicts an illustrative schematic diagram for an enhanced TSN network, in accordance with one or more example embodiments of the present disclosure.

FIG. 9 depicts an illustrative schematic diagram for an enhanced TSN network, in accordance with one or more example embodiments of the present disclosure.

FIG. 10 depicts an illustrative schematic diagram for redundancy for wireless time-sensitive networking (WTSN), in accordance with one or more example embodiments of the present disclosure.

FIG. 11 depicts an illustrative schematic diagram for redundancy for WTSN, in accordance with one or more example embodiments of the present disclosure.

FIG. 12 depicts an illustrative schematic diagram for redundancy for WTSN, in accordance with one or more example embodiments of the present disclosure.

FIG. 13 depicts an illustrative schematic diagram for redundancy for WTSN, in accordance with one or more example embodiments of the present disclosure.

FIG. 14 depicts an illustrative schematic diagram for redundancy for WTSN, in accordance with one or more example embodiments of the present disclosure.

FIG. 15 FIG. 13 depicts an illustrative schematic diagram for redundancy for WTSN, in accordance with one or more example embodiments of the present disclosure.

depicts an illustrative schematic diagram for redundancy for WTSN, in accordance with one or more example embodiments of the present disclosure.

FIG. 16 depicts an illustrative schematic diagram for redundancy for WTSN, in accordance with one or more example embodiments of the present disclosure.

FIG. 17 depicts an illustrative schematic diagram for redundancy for WTSN, in accordance with one or more example embodiments of the present disclosure.

FIG. 18 illustrates a flow diagram of an illustrative process for time-sensitive networking, in accordance with one or more example embodiments of the present disclosure.

FIG. 19 illustrates a functional diagram of an exemplary communication station that may be suitable for use as a user device, in accordance with one or more example embodiments of the present disclosure.

FIG. 20 illustrates a block diagram of an example machine upon which any of one or more techniques (e.g., methods) may be performed, in accordance with one or more example embodiments of the present disclosure.

FIG. 21 is a block diagram of a radio architecture in accordance with some examples.

FIG. 22 illustrates an example front-end module circuitry for use in the radio architecture of FIG. 21, in accordance with one or more example embodiments of the present disclosure.

FIG. 23 illustrates an example radio IC circuitry for use in the radio architecture of FIG. 21, in accordance with one or more example embodiments of the present disclosure.

FIG. 24 illustrates an example baseband processing circuitry for use in the radio architecture of FIG. 21, in accordance with one or more example embodiments of the present disclosure.

### DETAILED DESCRIPTION

Example embodiments described herein provide certain systems, methods, and devices for time-sensitive networking in wireless communications. The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

The IEEE 802.1 time-sensitive networking (TSN) standards enable time synchronization, guarantee latency, and high reliability (e.g., over wired/Ethernet links) through bandwidth reservation, and facilitate time-aware scheduling and redundancy over Ethernet local area networks (LANs).

Wireless communications may benefit from efforts to investigate requirements and issues with regard to controlling latency and increasing reliability for real-time applications including gaming, robotics, and industrial automation. Integration of IEEE 802.11 standards with a broader IEEE 802.1 (TSN-enabled) network may enable better control of latency and improve reliability/robustness for IEEE 802.11 communications.

The IEEE 802.11ak amendment has defined architectural components to help make an 802.11 network appear as a general purpose IEEE 802 LAN. In particular, IEEE 802.11ak introduces the concept of an 802.11 General Link (GLK) for operation with an IEEE 802.1Q Network. Because TSN standards may be defined within the context of IEEE 802.1Q LANs, IEEE 802.11ak enables key capabilities to connect Ethernet and 802.11 networks. However, IEEE 802.11ak may benefit from enabling integration with TSN capabilities with IEEE 802.11, such as the IEEE 802.1Qcc network management model and time-aware (e.g., IEEE 802.1Qbv) scheduling capabilities.

One area for improvement may include the discovery and integration of TSN-enabled 802.11 devices within a TSN Domain. A TSN Domain may be defined as an IEEE 802.1Q LAN which supports TSN capabilities (e.g., time-synchronized, deterministic time-aware data delivery, etc.) for high priority (e.g., TSN) traffic streams. The TSN Domain may be managed according to an IEEE 802.1Qcc model, in which a Central User Configuration (CUC) may collect information about the TSN streams, and the centralized network configuration (CNC) may use this information to perform admission control, define and deploy resource allocation strategies (e.g., Time-Aware/802.1Qbv Scheduling) to meet the required time-sensitive performance. Currently, there is no mechanism for the CUC/CNC to discover an IEEE 802.11 basic service set (BSS) that supports TSN capabilities (e.g., TSN-enabled) and admit the BSS within the TSN Domain. As part of this discovery process, there is a need for IEEE 802.11 devices (e.g., access points and station devices) to discover TSN capabilities within a BSS and announce such capabilities to TSN management entities.

Another area for improvement may include IEEE 802.11 TSN capability configuration. Once the TSN-enabled IEEE 802.11 network is discovered by the TSN Domain, new interfaces and protocols may be required to configure and/or update the configuration of TSN capabilities available in the IEEE 802.11 network (e.g., access points and station devices). Given the unique characteristics of the wireless media and the IEEE 802.11 network, the TSN capabilities may need different/new parameters compared to what has been enabled by existing Ethernet TSN standards.

Currently, there are no standard mechanisms to enable the discovery and configuration of TSN capabilities within an IEEE 802.11 network and between an IEEE 802.11 network and a TSN domain. New capabilities may be required for the integration of TSN-enabled 802.11 devices with a broader TSN infrastructure. Some of the new features may be included in the IEEE 802.11 specification and others may be included within the IEEE 802.1Q specifications (e.g., IEEE 802.1Qcc).

Recently, the need to improve latency and reliability has been introduced in new IEEE 802.11 standard initiatives. A Real-Time Applications Top Interest Group (RAT-TIG) has been created within the IEEE 802.11 working group to investigate the requirement and issues to control latency and increase reliability for real-time applications including gaming, robotics, and industrial automation. The low latency requirement has also been introduced as a goal for the next major 802.11 release, which will be called EHT (Extreme High Throughput) under development by the 802.11be Task Group.

The IEEE 802.1 time-sensitive networking (TSN) standards are being developed to enable time synchronization, guarantee latency, and high reliability (primarily over wired/Ethernet links) through bandwidth reservation, time-aware scheduling, and redundancy. Time synchronization is already supported over 802.11 (e.g., Timing Measurements and Fine Timing Measurements), but other TSN concepts have not yet been extended to Wi-Fi/802.11 standards. An extension of the time-aware traffic shaping (802.1Qbv) capabilities has been proposed which helps control congestion and improve latency.

Another area for improvement that has been recently proposed in 802.11 is reliability through multiple links. A similar problem is addressed in Ethernet TSN with frame replication defined in the 802.1CB standard.

In one or more embodiments, solutions are provided that enable the extension of the 802.1CB standard over 802.11 through coordination of APs across multiple channels and bands.

It is challenging to provide a wireless link with high reliability and low latency for time-sensitive networks (TSN) over unlicensed bands (e.g., Wi-Fi) due to the fading, obstruction between the AP and the stations, and also the interference. When a large object blocks the direct path between the AP and a station device (STA), the link between the AP and STA may be lost. On the other hand, if another device with Wi-Fi on is accidently brought into the environment, the AP or the station may not be able to access the channel or may lose the link due to the co-channel interference. The station in this example may be a sensor/actuator device in a factory, a gaming device, or an AR/VR device. All these applications need TSN capabilities.

Example embodiments of the present disclosure relate to systems, methods, and devices for time-sensitive networking (TSN) in wireless communications.

In one or more embodiments, the proposed solution may determine how to enable an 802.11 network to be discovered and to be configured. In this architecture, there may be a wired/wireless part. The architecture may facilitate a mechanism for the 802.11 network to announce its capability to handle TSN traffic. In that sense, STAs that are serviced by the AP of the 802.11 network may be able to exchange TSN capability information with the AP.

In one or more embodiments, the proposed solution may include multiple parts, such as TSN capability discovery within an IEEE 802.11 network; TSN capability discovery between an 802.11 device/network and a TSN management entity (e.g., CNC); and TSN capability configuration and adaptation interfaces and protocol within the 802.11 network and between the 802.11 network and the TSN management entity.

In one or more embodiments, the proposed architecture and protocol enhancements may enable the integration of TSN-enabled 802.11 devices within a broader TSN network. The enhancements also may enable configuration and management of TSN capabilities within the 802.11 network to better support time-sensitive applications, such as gaming, robotics, industrial automation, etc.

In one or more embodiments, the 802.11 network may be fully managed, for instance, according to the IEEE 802.1Qcc management model. Other management models (e.g., distributed and hybrid) are possible and are described in the IEEE 802.1Qcc standard. The network may be managed by a single entity that may plan the deployment and resolve potential interference between Overlapping Basic Service Set (OBSS) at planning and configuration stages.

In one or more embodiments, some of the applications of the proposed architecture may include industrial, robotics, gaming, Augmented reality (AR), virtual reality (VR), or other applications where the timing is an important factor such as real-time application.

Example embodiments of the present disclosure relate to systems, methods, and devices for Enable redundancy for wireless time-sensitive networking with multi-AP coordination and multi-band/channel operation technology.

In one embodiment, a redundancy for wireless time-sensitive networking (WTSN) system may facilitate an enhanced WTSN that can provide reliable transmission between the AP and the sensor/Actuator with multiple AP coordination and multiple band/channel operation technology. This can also improve the latency performance by reducing the channel access delay with multiple band/channel operation technology.

One or more assumptions may be used:

1) Sensor and actuator support concurrent multiple band/channel transmission with multiple radios.

2) All the APs are connected over wired connections to a wireless TSN controller. Note, all the APs may be also connected over wireless to the wireless TSN controller.

3) All the APs do not need to support concurrent multiple band/channels transmission to enable this algorithm. For simplicity, it may be assumed that all of them support concurrent multiple band/channels transmission with multiple radios, which would be most of the cases in the future.

4) All the APs support multiple AP coordination and the coordination is setup through backhaul by the wireless TSN controller. The wireless TSN controller will define:

The associated AP for each STA. This is known to the STA.

The coordinated APs for each STA. This may be not known to the STA, but known to the APs. All the coordinated APs are requested to operate as relay and forward the data packet between the wireless TSN controller and the STA. In one embodiment, the wireless TSN controller may also implement the discovery and configuration of TSN capabilities between the wireless domain and the TSN management entity.

In the uplink, multiple coordinated APs in different locations and operating at the same channel are requested to receive the uplink data packet sent from the same sensor or same set of sensors (UL MU OFDMA/MIMO) and forward to the wireless TSN controller to improve the uplink reliability with multiple path diversity.

In the downlink, multiple coordinated APs in different locations and operating at the same channels are requested to forward the same data packet distributed from the wireless TSN controller to the same actuator or a same set of actuators (DL MU OFDMA/DL MU MIMO) at the same time to improve the downlink reliability with higher receive signal strength.

Assuming that the sensor is multi-band capable and is able to receive the downlink (send uplink) data packet over multiple channels independently. A redundancy layer is added on top of the MAC for packet replication and elimination. Therefore, for the packet generated from the up layer, it will be duplicated and be sent to the STA through the two MAC/PHY over two different channels independently. At the receiver side, for duplicated packet received over different channels, it will be eliminated in the redundancy layer according to the sequence number. As a result, it can mitigate the problem due to the co-channel interference.

In one embodiment, a redundancy for WTSN system may provide a wireless link with high reliability and low latency for time-sensitive networks over unlicensed bands with multiple AP coordination and multiple band/channel operation technology.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

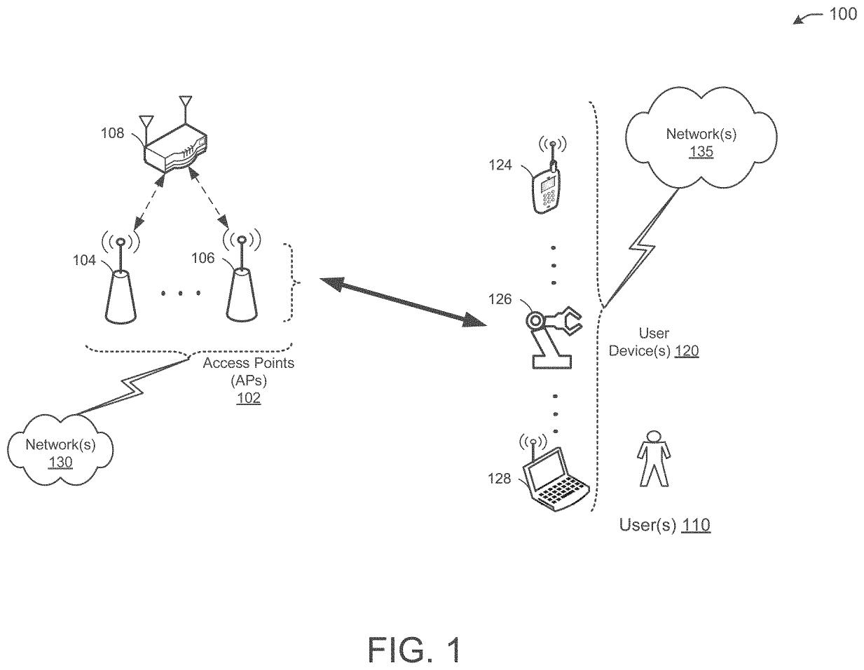

FIG. 1 is a network diagram illustrating an example network environment of enhanced TSN network, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

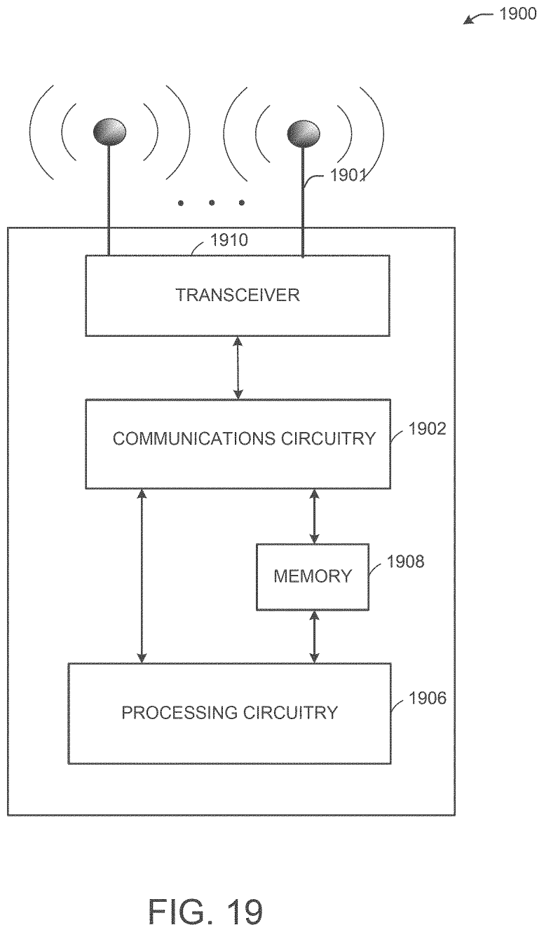

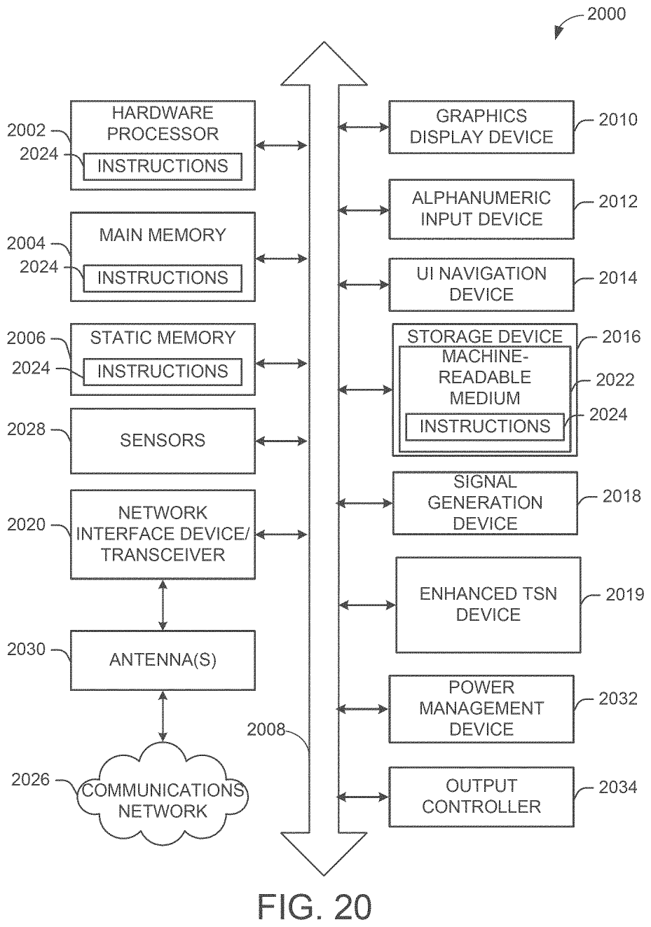

In some embodiments, the user devices 120 and the AP 102 may include one or more computer systems similar to that of the functional diagram of FIG. 19 and/or the example machine/system of FIG. 20.

One or more illustrative user device(s) 120 and/or AP(s) 102 may be operable by one or more user(s) 110. It should be noted that any addressable unit may be a station (STA). An STA may take on multiple distinct characteristics, each of which shapes its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

In one or more embodiments, a controller 108 (e.g., a wireless TSN controller) may facilitate enhanced coordination among multiple APs (e.g., AP 104 and AP 106). The controller 108 may be a central entity or another AP, and may be responsible for configuring and scheduling time-sensitive control and data operations across the APs. A wireless TSN (WTSN) management protocol may be used to facilitate enhanced coordination between the APs, which may be referred to as WTSN management clients in such context. The controller 108 may enable device admission control (e.g., control over admitting devices to a WTSN), joint scheduling, network measurements, and other operations. APs may be configured to follow the WTSN protocol.

In one or more embodiments, the use of controller 108 may facilitate AP synchronization and alignment for control and data transmissions to ensure latency with high reliability for time-sensitive applications on a shared time-sensitive data channel, while enabling coexistence with non-time-sensitive traffic in the same network.

In one or more embodiments, the controller 108 and its coordination may be adopted in future Wi-Fi standards for new bands (e.g., 6-7 GHz), in which additional requirements of time synchronization and scheduled operations may be used. Such application of the controller 1 108 may be used in managed Wi-Fi deployments (e.g., enterprise, industrial, managed home networks, etc.) in which time-sensitive traffic may be steered to a dedicated channel in existing bands as well as new bands.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, 802.11ax), 5 GHz channels (e.g., 802.11n, 802.11ac, 802.11ax), or 60 GHZ channels (e.g., 802.11ad, 802.11ay). 800 MHz channels (e.g., 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, AP 102 may facilitate enhanced TSN network with one or more user devices 120, which may include association request and response frames having TSN information, or any other type of frame with TSN information.

It is understood that the above descriptions are for purposes of illustration and are not meant to be limiting.

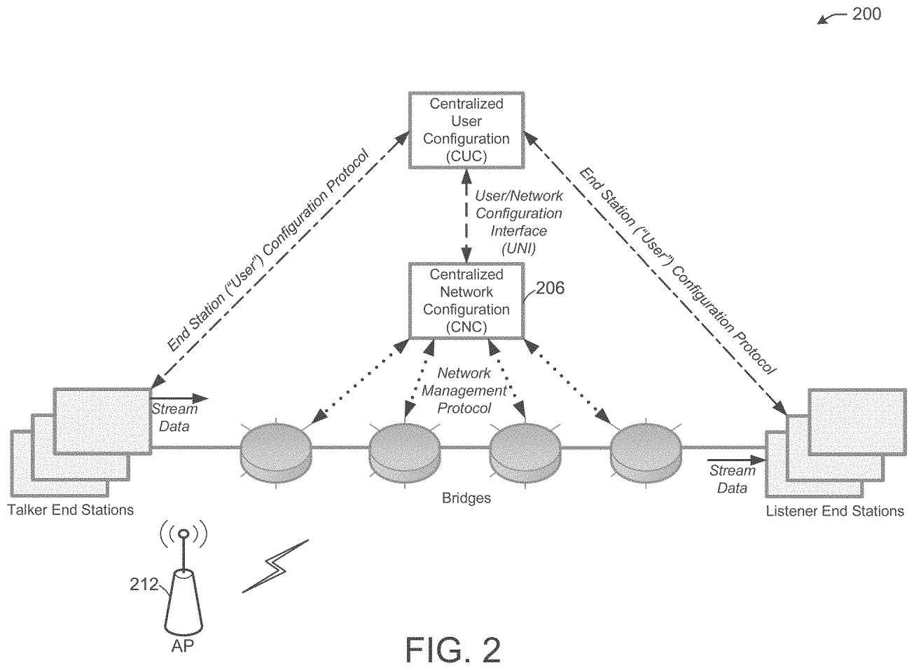

FIG. 2 depicts an illustrative schematic diagram 200 for IEEE 802.11Qcc Centralized TSN Management Model.

As shown in FIG. 2, a TSN Domain may be managed according to an IEEE 802.1Qcc model, which may need to connect to an 802.11 network through an AP 212.

A TSN Domain may be managed according to an IEEE 802.1Qcc model, in which a Central User Configuration (CUC) may collect information about the TSN streams, and the Centralized Network Configuration (CNC) may use this information to perform admission control, define and deploy resource allocation strategies (e.g., Time-Aware/802.1Qbv Scheduling) to meet the required time-sensitive performance. There is no mechanism for the CUC/CNC to discover an 802.11 BSS that supports TSN capabilities (TSN-enabled) and admit the BSS within the TSN Domain. As part of a discovery process, there may be a need for the access points (APs) and station devices (STAs) to discover TSN capabilities within the BSS and announce such capabilities to the TSN management entities.

It may be assumed that an IEEE 802.11 network is fully managed, for example, according to the IEEE 802.1Qcc management model. Other management models (e.g., distributed and hybrid) may be possible and are described in the IEEE 802.1Qcc standard. The network may be managed by a single entity that may plan the deployment and resolve potential interference between Overlapping Basic Service Set (OBSS) at the planning and configuration stages.

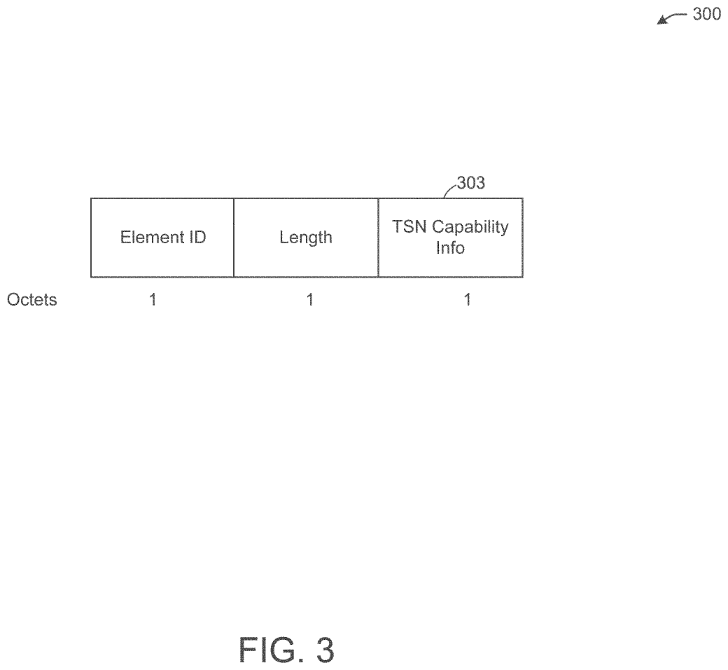

FIG. 3 depicts an illustrative schematic diagram 300 for an example format of a TSN capability element, in accordance with one or more example embodiments of the present disclosure.

FIG. 3 illustrates an example format of a TSN capability element to include in a frame. Wherein the TSN capability element comprises an Element ID field, a Length field, and a TSN capability information field 303.

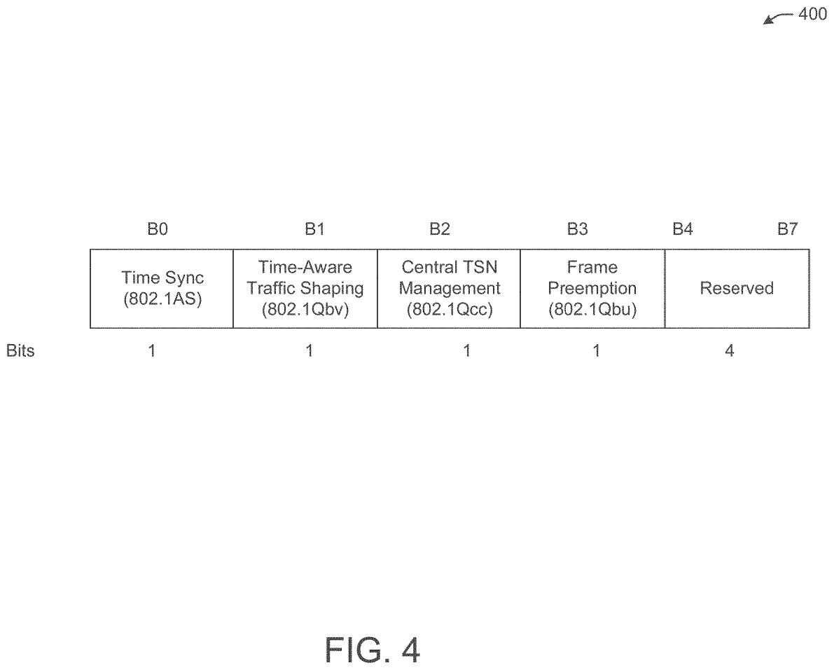

FIG. 4 depicts an illustrative schematic diagram 400 for an example TSN capability information field, in accordance with one or more example embodiments of the present disclosure.

Referring to FIG. 4, there is shown a TSN capability information field that may be included in a frame and exchanged between an STA and an AP.

For example, the AP supporting TSN capabilities may include a TSN Capability element in its beacons and/or probe response frames to advertise its TSN capabilities to STAs. STAs may use the TSN capabilities advertised by the AP to decide on whether to associate with the AP.

In one or more embodiments, an STA may include a TSN Capability element in an Association Request frame sent to an AP during an Association procedure. Such may allow the AP to discover TSN-enabled STAs within a BSS. The TSN Capability information field may indicate specific TSN capabilities supported by the STA, such as time synchronization (e.g., based on an IEEE 802.1AS protocol), time-aware traffic shaping (e.g., based on an IEEE 802.1Qbv procedure), centralized TSN management (e.g., as defined in IEEE 802.1Qcc), and frame preemption (e.g., as defined in IEEE 802.1Qbu). Other TSN features applicable to 802.11 may also be included in the future using the reserved bits.

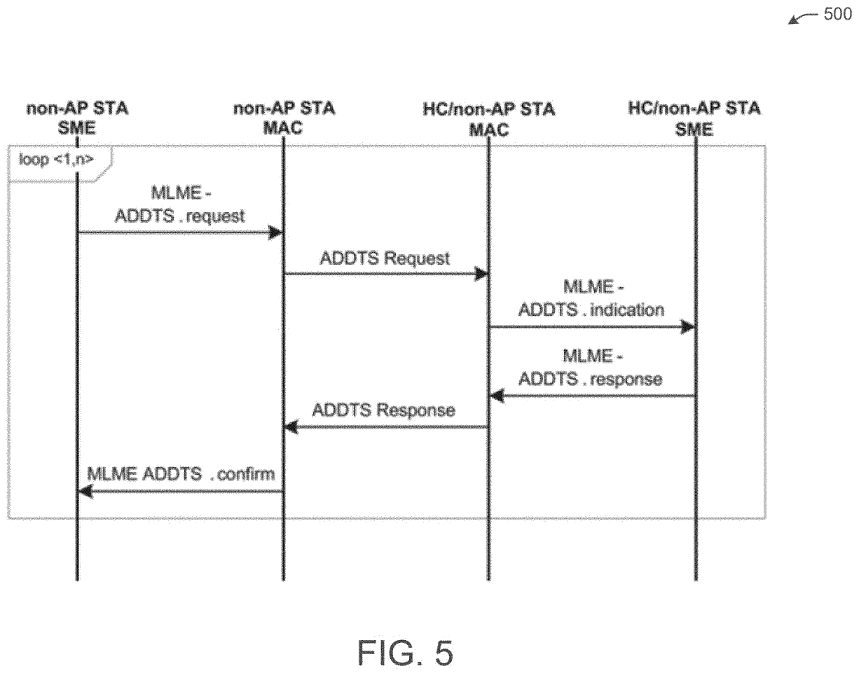

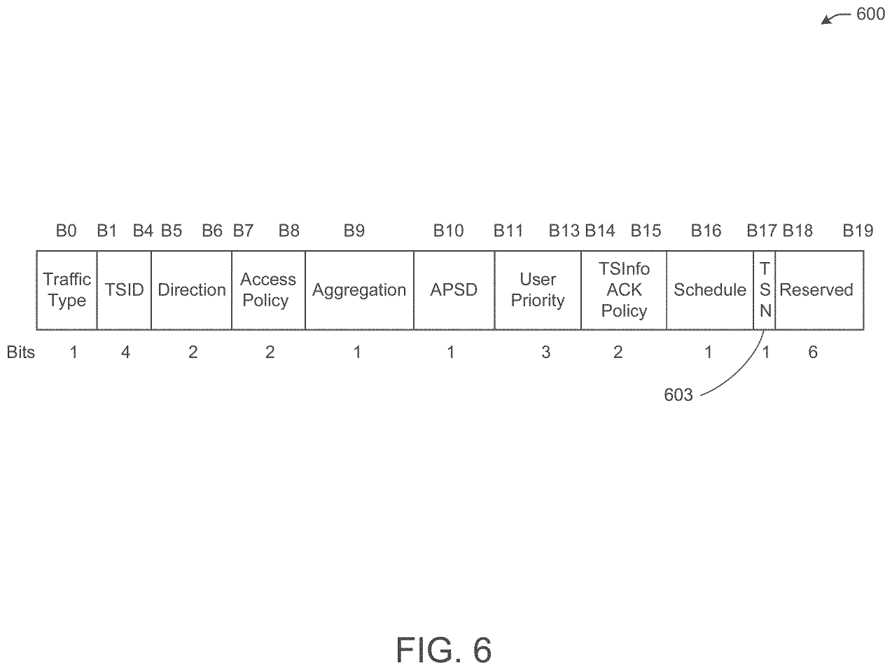

In one or more embodiments, if an AP does not support TSN capabilities, the AP may ignore the TSN Capability element sent by STAs during association. If the AP supports TSN capabilities, the AP may admit the STA within the BSS and wait for the STA to trigger the activation of TSN streams, (e.g., through a STA initiated traffic stream set up procedure as shown in FIG. 5). This procedure is already defined by the IEEE 802.11-2016 specification, but the STA may indicate whether the traffic stream requests TSN services by including a TSN bit 603 (e.g., B17) in the traffic stream (TS) Information field part of a traffic specification (TSPEC) element as shown below in FIG. 6. Additional information may be included in the TSPEC to describe the TSN flow, such as periodicity, maximum packet/burst size, latency deadlines and reliability requirements. A TSPEC is an information element (IE) that is sent from a QoS-capable wireless client that requests for a certain QoS (Quality of Service) treatment from an AP for the traffic stream (TS) it represents. The AP may then decide whether the request is acceptable or not and provides its decision to the client.

FIG. 5 depicts an illustrative schematic diagram 500 for a time-sensitive setup, in accordance with one or more example embodiments of the present disclosure.

FIG. 6 depicts an illustrative schematic diagram 600 for time-sensitive information field, in accordance with one or more example embodiments of the present disclosure.

In one or more embodiments, when the AP receives a request (e.g., from higher layers) to set up a TSN stream with a given TSN-enabled STA, the AP may trigger an admission control procedure to decide whether to admit the new TSN stream for the STA. This procedure may include the AP initiated Traffic Stream establishment as shown in FIG. 6, where the Higher Layer quality of service (QoS) Request and Higher layer Stream identifier (ID) may identify the TSN stream. The AP also may set the new TSN bit 603 in the traffic stream (TS) information field in traffic specification (TSPEC) element transmitted in an add traffic stream (ADDTS) Reserve Request frame to indicate the traffic stream is a TSN traffic stream. TSN bit 603 is set to 1 to indicate support for TSN traffic and is set to 0 to indicate no support for TSN traffic. The TS information field is included in the TSPEC element and may comprise one or more subfields. For example, the TS information field comprises a traffic type subfield, a TSID subfield, a direction subfield, an access policy subfield, an aggregation subfield, an automatic power save delivery (APSD) subfield, a user priority subfield, a TS Info Ack policy subfield, a schedule subfield, a TSN subfield 603, and a reserved subfield. The Traffic Type subfield is a single bit and is set to 1 for a periodic traffic pattern or 0 for an aperiodic traffic pattern. The TSID subfield is 4 bits in length and contains a value that is a TSID. The Direction subfield specifies the direction of data carried by the TS. The Access Policy subfield is 2 bits in length, specifies the access method to be used for the TS. The Aggregation subfield is 1 bit in length. The APSD subfield is a single bit and is set to 1 to indicate that automatic PS delivery is to be used for the traffic associated with the TSPEC and set to 0 otherwise. The user priority subfield is 3 bits and indicates the actual value of the user priority to be used for the transport of frames belonging to these TS when relative prioritization is required. The TS Info Ack Policy subfield is 2 bits in length and indicates whether MAC acknowledgments are required for MPDUs or A-MSDUs belonging to this TSID and the form of those acknowledgments.

In another embodiment, the TSN stream requirements may also be included in another management frame exchanged between the STA and AP. The TSN stream set up may be initiated by the STA or by the AP.

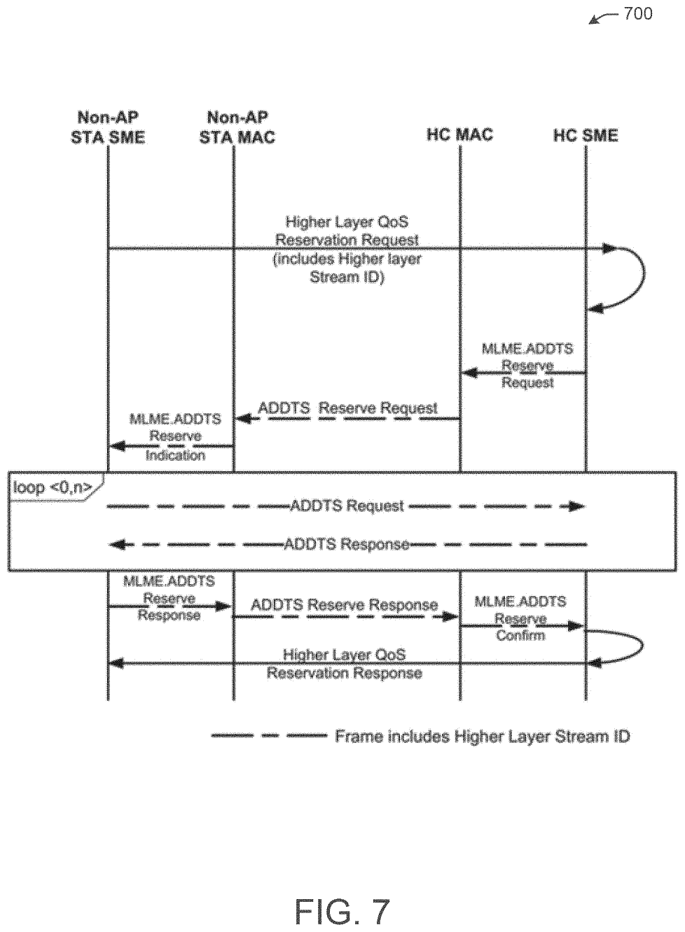

FIG. 7 depicts an illustrative schematic diagram 700 for time-sensitive setup when initiated by an AP, in accordance with one or more example embodiments of the present disclosure.

TS setup may be initiated by an AP in response to a request originating from higher layer protocols. The AP initiates the TS setup by sending an ADDTS Reserve Request frame that includes the Higher Layer Stream ID element to the non-AP STA. On receipt of the ADDTS Reserve Request frame from the AP, the non-AP STA shall perform one of the following:

1) Complete the AP-initiated TS setup procedure by sending an ADDTS Reserve Response frame that includes the Higher Layer Stream ID corresponding to the AP-initiated TS setup procedure and with the status code set to “SUCCESS.”

2) Send an ADDTS Reserve Response frame with a status code not equal to SUCCESS and abort the AP-initiated TS setup. The Higher Layer Stream ID field in this ADDTS Reserve Response frame shall be set to the Higher Layer Stream ID corresponding to the AP-initiated TS setup procedure.

3) Send an ADDTS Request frame to the AP. There might be multiple ADDTS Request/ADDTS Response exchanges between the non-AP STA and the AP to negotiate the TSPEC parameters. The Higher Layer Stream ID may be included in all frames corresponding to the AP-initiated TS setup procedure that are exchanged between the non-AP STA and the AP. The AP-initiated TS setup procedure is completed by sending an ADDTS Reserve Response frame that includes the Higher Layer Stream ID corresponding to the AP-initiated TS setup procedure and with the status code set to indicate the result of the TSPEC negotiation.

Given the challenges in meeting TSN performance in wireless networks, it is expected that TSN support in the STA is not enough to achieve TSN goals in practice. Therefore, both APs and STAs may need to support TSN capabilities in order to enable the successful integration of an IEEE 802.11 network with a TSN domain.

If an AP supports TSN capability at the 802.11 medium access control/physical layer (MAC/PHY) layer, and if the AP is part of an IEEE 802.1Q (e.g., TSN-enabled) network, the AP may expose the IEEE 802.11 TSN capabilities to higher layer (TSN) protocols, which may be responsible for managing and configuring the TSN infrastructure. FIG. 7 shows a new IEEE 802.1Q TSN Management module included as part of the Station Management Entity (SME) within an AP, which may communicate with a remote TSN Management Entity (e.g., CNC) in the broader TSN domain. The 802.11 STAs also may include a new 802.1Q TSN Management module, if the STA is TSN-enabled. The STAs may communicate through the AP with the remote TSN Management Entity.

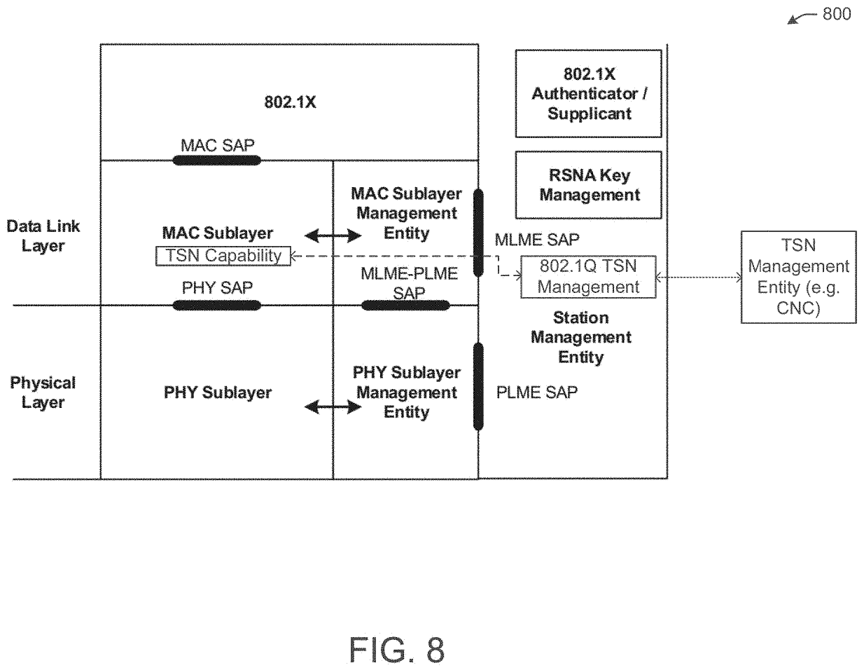

FIG. 8 depicts an illustrative schematic diagram 800 for an enhanced TSN network, in accordance with one or more example embodiments of the present disclosure.

Referring to FIG. 8, there is shown a portion of the reference model.

In one or more embodiments, the TSN Management Entity may be responsible for discovering the TSN Capabilities in the 802.11 network. For example, if the centralized TSN management model is used, the CNC may act as the TSN Management Entity client and may access a TSN management server running at the AP/STA. The management server (e.g., an IEEE 802.1Q/higher layer application) may access the 802.11 TSN Capabilities through the 802.1 TSN Management module in the SME and translate the 802.11 specific TSN capabilities (e.g., time synchronization accuracy, time-aware support, redundancy, etc.) to the TSN capabilities exposed to the CNC (e.g., 802.1AS, 802.1Qbv, 802.1Qcu, etc.).

Given the unique characteristics of wireless networks, it may be useful to expose additional information to the CNC. The new information may be used by the CNC to take into account wireless specific performance targets such as minimal bounded latency supported, expected reliability, the stability of the link (e.g., whether mobility is expected to impact the link or signal strength quality). IEEE 802.11 specific TSN parameters may be exposed to the higher layers by 802.1Q TSN management SME interface.

In one embodiment the 802.11 TSN parameters may be defined by TSN-specific TSPECs (or similar signaling mechanisms) set up for TSN traffic within the 802.11 network. The TSN-specific TSPEC set up between the STA and AP may be accessed by the 802.1Q TSN Management module in the SME and forwarded to the remote TSN Management Entity (e.g., CNC).

In another embodiment, new 802.11 specific TSN parameters used to set up TSN traffic streams between STAs and AP may also be defined as part of the 802.1Qcc management model and exchanged between the wireless TSN domain and the CNC. In one or more embodiments, these new parameters are included in the ADDTSReq frame exchanged by the STA and AP as part of TSN traffic stream set up/activation. These parameters may also be defined based on the 802.11 TSPEC and may include:

Minimum latency bound supported at the MAC SAP (Service Access Point);

Minimum jitter supported;

Maximum Payload Size accepted: maximum MAC layer frame payload that can be supported under TSN-grade service levels;

Minimum Service Interval: minimum packet arrival interval that can be supported for a TSN stream;

Reliability level: a measure of the probability that a packet is delivered within a certain latency bound (e.g., 99 to 99.999% or higher). Alternatively, this also may be represented as a packet error rate that may be supported.

Link stability index: a measure of the stability of the links. It may be used to represent a range of links, from static links, which are not expected to change very much, to mobile links, which are expected to change frequently and require more active management.

The above parameters may be exchanged between the 802.1Q TSN Management module in the 802.11 SME and a remote TSN Management Entity as part of a higher layer protocol, such as 802.1Qcc. The 802.11 parameters may be exchanged between the 802.1Qcc client and services running in the CNC and the 802.11 AP/STAs, respectively. This may enable the configuration of TSN capabilities within the 802.11 network and across the overall TSN Domain. The 802.11 specific TSN parameters may also be added as part of 802.1Qcc elements or they may be mapped to a corresponding or new parameters in 802.11Qcc.

The exchange of TSN parameters between the BSS devices (AP and STA) and the CNC may happen at initialization/configuration stages and also through normal operation, for example, instance as a result of any changes in the wireless network performance that may require adaptation of the TSN streams being served or the TSN capabilities being offered. For example, if the wireless network is experiencing higher interference and packet errors, the AP may indicate a change in the TSN reliability parameter to the CNC, which may take actions to manage the network accordingly (e.g., add new paths/re-route the traffic to a more reliability link, if available).

FIG. 8 summarizes the interactions between the TSN management modules within the STA/AP and the TSN Management Entity (e.g., CNC). Note that different exchanges may happen at different times during the initialization/association, and normal operation of the network. The STA may send its TSN capabilities to the AP during association. The CNC may query the AP's capabilities during the TSN network initialization and/or any other time during normal operation. The 802.11-specific TSN parameters discussed may also be included with the TSN Capability Response message sent by the AP to the CNC. Furthermore, the CNC may configure the AP's TSN capabilities at any point, and the AP is responsible for updating the TSN capability configuration with the BSS.

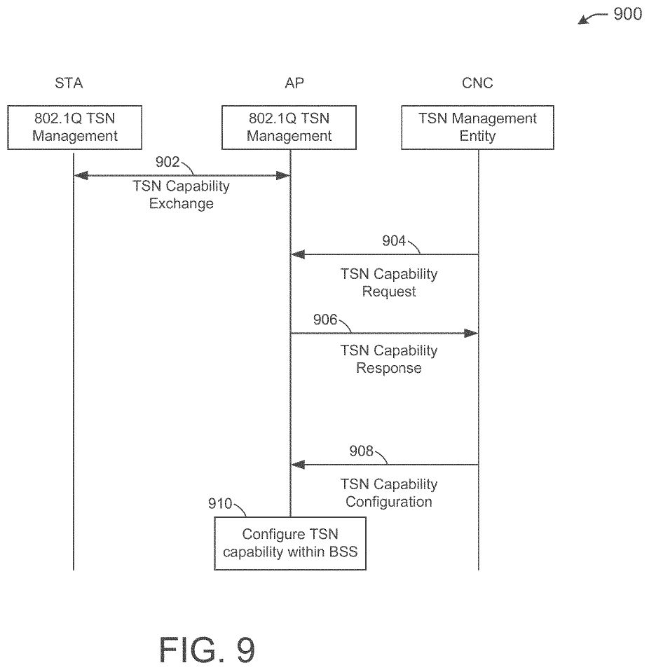

FIG. 9 depicts an illustrative schematic diagram 900 for an enhanced TSN network, in accordance with one or more example embodiments of the present disclosure.

Referring to FIG. 9, there is shown example interactions between TSN management modules. In FIG. 9, another step (not shown) may include the advertisement of the AP TSN capabilities before the STA sends its capabilities to the AP.

In another embodiment, the TSN flow requirements may be exchanged between AP and STAs (it may be initiated by either side, depending on the use case) as a result of a TSN management (CNC) capability configuration (last step in FIG. 9). The CNC may decide on an end to end schedule for the TSN flow and it may provide the AP (or STA) with the required flow parameters for the wireless link (e.g., max packet size, max latency/jitter, reliability, as described above) in a TSN capability configuration request. This configuration request may trigger the STA and/or AP (depending on the direction of the flow) to send a TSPEC with the TSN flow requirements. For instance, after receiving a configuration from the CNC, the STA may send a TSPEC with TSN parameters to the AP and the AP can confirm the admission of the TSN flow. After that, the AP can use any of its capabilities to transfer the TSN frames according to the requirements provided in the TSN TSPEC.

TSN Capability Exchange 902: here, the STA and AP may exchange TSN capabilities. The AP (broadcasting the TSN Capability bit in the beacon) or STA (setting the TSN capability bit in a probe request or admission control request signaling) may initiate this exchange. For example, the AP may send a beacon frame that may comprise a TSN bit that may be set to 1 to indicate that the AP support TSN traffic. Otherwise, if the TSN bit is set to 0, it indicates to the STA that the AP does not support TSN traffic. Similarly, the STA may set the TSN bit to 1 to indicate to the AP that the STA support TSN traffic or may set the TSN bit to 0 to indicate to the AP that the STA does not support TSN traffic.

TSN Capability Request 904: As part of the network configuration the CNC can request (discover) TSN Capabilities from the AP.

TSN Capability Response 906: the AP responds to the request including information from its TSN capabilities (which TSN tools are supported: time sync, IEEE 802.1Qbv, channel bonding (CB), preemption . . . ) it supports in the network. The AP may also include information on behalf of the STAs. Alternatively, the AP may respond with the set of TSN capabilities that are jointly supported by the AP and its associated STAs.

TSN Capability Configuration 908: The CNC may use the AP/STAs capabilities to define a specific configuration for the wireless TSN domain (e.g., protected time windows for IEEE 802.1Qbv schedule indicating when time-critical traffic will arrive and what is the deadline for transmission, redundancy requirements for a flow).

Configure TSN capability within BSS 910: The AP uses the CNC configuration as requirements/input to manage the wireless communication resources within the BSS. For instance, the AP may reserve period of time for time-critical traffic only, the AP may adapt its trigger-based scheduling behavior (if 802.11ax or similar capability is used) to prioritize traffic/STAs in order to meet the requirements defined by the TSN configuration.

It is understood that the above descriptions are for purposes of illustration and are not meant to be limiting.

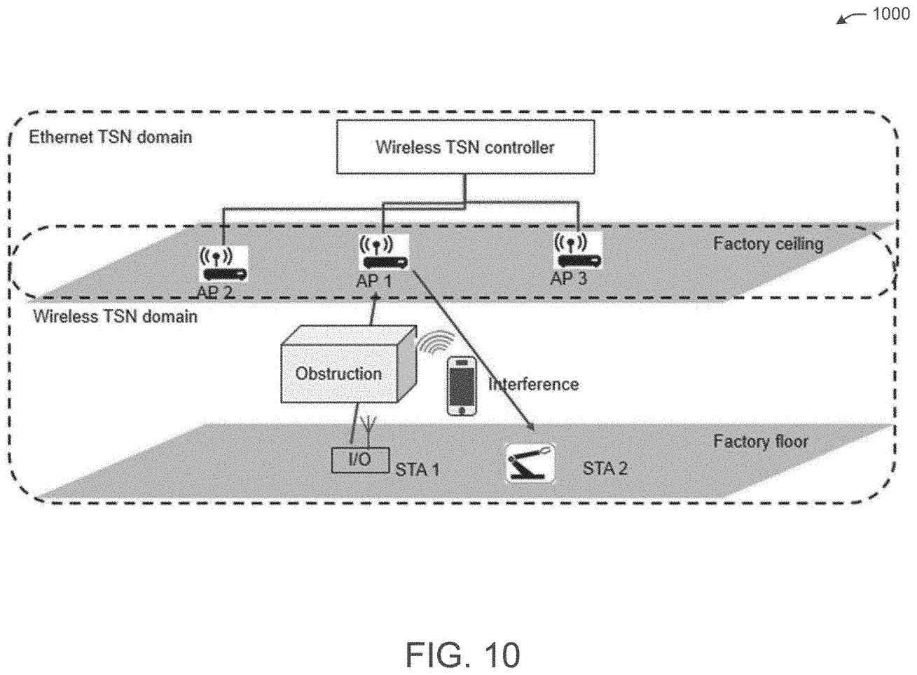

FIG. 10 depicts an illustrative schematic diagram 1000 for redundancy for WTSN, in accordance with one or more example embodiments of the present disclosure.

Referring to FIG. 10, there is shown the challenge of WTSN over an unlicensed band (e.g., Wi-Fi).

As shown in FIG. 10, there are three APs, which are wired to the wireless time sensing networking (WTSN) controller and operating over the same channel. For simplicity, other APs operating over other channels are not shown in this FIG. 10. Each AP is associated with multiple STAs, which can be sensors or actuators. For simplicity, only the STAs associated with AP1 are shown in this FIG. 10.

It is challenging to provide a wireless link with high reliability and low latency for time-sensitive networks over unlicensed bands due to the fading, obstruction between the AP and the stations, and also the interference. As shown in FIG. 10, when a large object blocks the direct path between the AP1 and station 1, the link between the AP1 and STA 1 may be lost. On the other hand, if another device with Wi-Fi is accidentally brought into the environment, the AP or the station may not be able to access the channel or may lose the link due to the co-channel interference. The station in this example may be a sensor/actuator device in a factory, a gaming device, or an AR/VR device. All these applications need TSN capabilities.

In this disclosure, the sensor/actuator example is used however; the one or more embodiments are broadly applicable to other real-time/time-sensitive applications.

Assuming that the sensor is multi-band capable and is able to receive the downlink (send uplink) data packet over multiple channels independently.

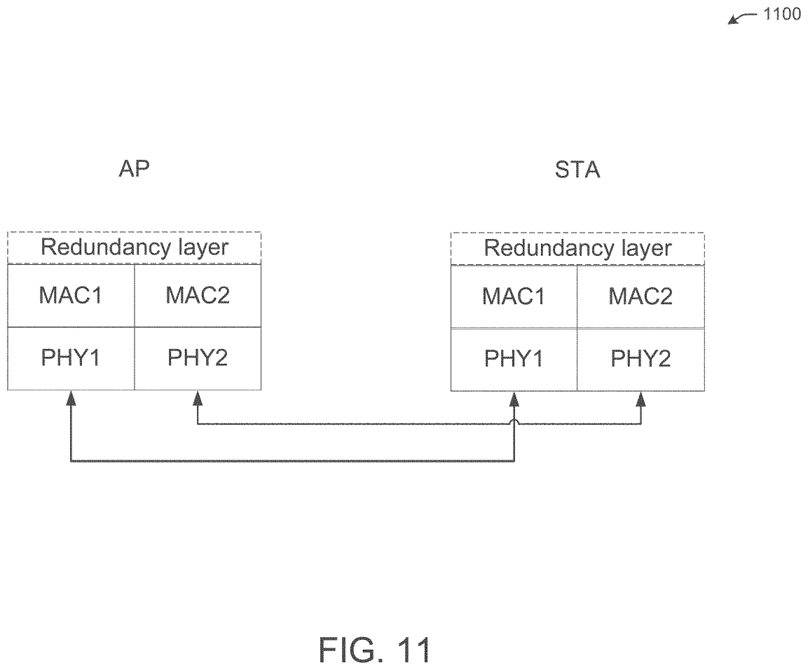

FIG. 11 depicts an illustrative schematic diagram 1100 for redundancy for WTSN, in accordance with one or more example embodiments of the present disclosure.

Referring to FIG. 11, there is shown a multi-channel operation.

As shown in FIG. 11, a redundancy layer is added on top of the MAC for packet replication and elimination. Therefore, for the packet generated from the up layer, it will be duplicated and be sent to the STA through the two MAC/PHY over two different channels independently. At the receiver side, for a duplicated packet received over different channels, it will be eliminated in the redundancy layer according to the sequence number. As a result, it can mitigate the problem due to co-channel interference.

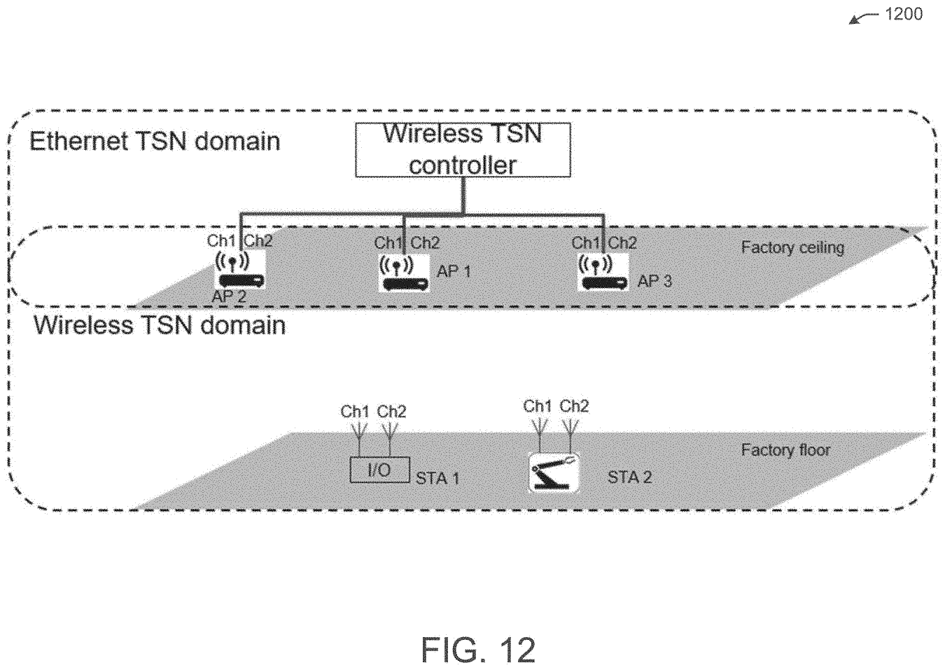

FIG. 12 depicts an illustrative schematic diagram 1200 for redundancy for WTSN, in accordance with one or more example embodiments of the present disclosure.

Referring to FIG. 12, there is shown an example of a wireless TSN configuration.

In one or more embodiments, there is shown an example of how to use multiple AP coordination and multi-band/channel operation technology to provide a wireless link with high reliability and low latency for time-sensitive networks over an unlicensed band (e.g., Wi-Fi). Assuming that there are three APs installed on the ceiling of the factory, one sensor and one actuator on the factory floor. Each AP is associated with multiple STAs. For simplicity, all the STAs associated with AP2 and AP3 are not shown in FIG. 12. All of the APs and STAs are operating over two or more overlapping channels with two or more radios at the same time. These channels can be two or more channels over the same band with a large guard band or two or more channels over different frequency bands, such as 2.4/5/6 GHz bands, and have some coordination among multiple channels, this will be described in the following procedures. In this example, all of the APs and STAs are operating over two channels, such as ch1 and ch2. AP1 is the associated AP of STA 1 and STA2. AP2 and AP3 are the coordinated APs of STA1 and STA2. In the following section, there is shown a description of how these three APs coordinate together to improve the performance of STA1 and STA2 with multi-band/channel operation technology.

Uplink Phase:

In one or more embodiments, the AP or the sensor subject to different requirements in different scenarios can initiate the uplink transmission.

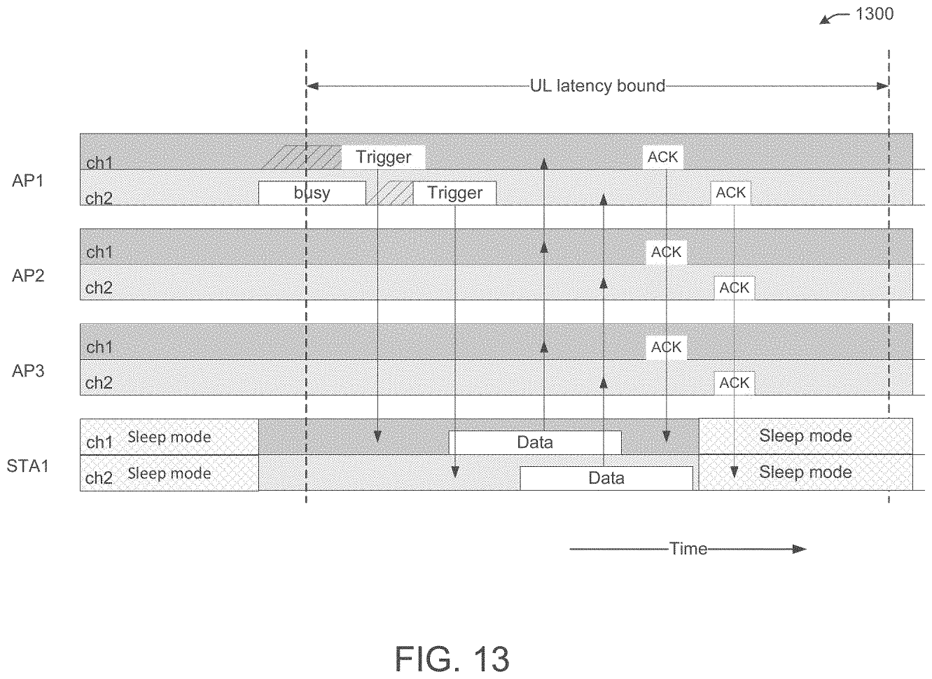

FIG. 13 depicts an illustrative schematic diagram 1300 for redundancy for WTSN, in accordance with one or more example embodiments of the present disclosure.

Referring to FIG. 13, there is shown an uplink transmission with multiple AP/band/channel.

In one embodiment, in Case 1) Uplink transmission is initiated by the AP:

AP1:

Based on the traffic pattern of the sensor, AP1 will start to contend the channel before the expected time that the uplink packet is generated at the sensor over all of the operation channels, such as ch1 and ch2, as shown in FIG. 13. Once it senses that any of the channels is available, it will send a trigger frame to the sensor over the available channel, such as ch1.

Sensor(STA1):

In one or more embodiments, upon the reception of the trigger frame over ch1, the sensor will prepare the uplink data packet with the transmission parameters indicated in the trigger frame and send it to the AP1 over ch1 with a sequence number added in the redundancy layer. (For the UL MU OFDMA, the trigger frame will also indicate the frequency resource unit that each sensor should use for the uplink packet transmission).

Note: To save power, the sensor will turn on the Wi-Fi radios over all the operating channels only in a certain time period based on the traffic pattern. As shown in FIG. 13, the sensor will turn on the Wi-Fi radio a short time before it generates the uplink data packet and turn off the Wi-Fi radio over all the operating channels once it receives the ACK frame from AP.

All the coordinated APs(AP1-AP3):

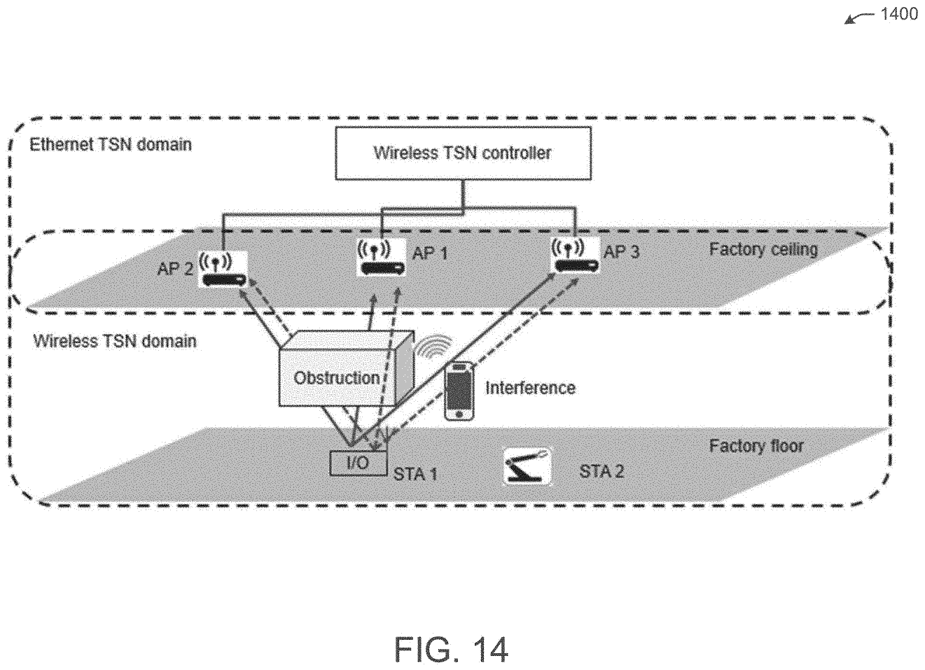

In one or more embodiments, all the APs who hear the uplink data packet over ch1 will start the packet reception as shown in FIGS. 4 and 5. If the packet is received correctly, the receiver address is one of the APs that the AP is coordinated with, or the destination address is the MAC address of the wireless TSN controller, it will forward the data packet to the Wireless TSN controller and also feedback the ACK to the sensor SIFS time after the reception of the uplink data packet. As a result, if the link between the sensor and one of the coordinated APs is blocked by any obstruction as shown in FIG. 14, the packet can still be received by other coordinated APs.

FIG. 14 depicts an illustrative schematic diagram 1400 for redundancy for WTSN, in accordance with one or more example embodiments of the present disclosure.

Referring to FIG. 14, there is shown an uplink phase of an industrial wireless network.

It should be noted that: The coordination among multiple APs is done through backhaul and managed by the wireless TSN controller.

Activity over ch2: as shown in FIG. 13, before the AP1 receives the uplink data packet from the sensor successfully, it will keep sensing the rest of the channel while transmitting the trigger frame to the sensor or receiving the uplink data packet from the sensor. Once it senses that any one of the rest of the channels is available and the time left to the UL latency bound is long enough to trigger the sensor to send the uplink data packet, it will start to send the trigger frame to the sensor over the available channel as shown in FIG. 13. In this way, the sensor can send uplink data packet to the AP over multiple different channels independently. As a result, if there is co-channel interference over one of the operation channels, the sensor is still able to access another operation channel to send a data packet to the AP as shown in FIG. 14.

In one embodiment, in Case 2) Uplink transmission is initiated by the sensor:

Sensor(STA1):

In one or more embodiments, when the sensor has an uplink data packet to send to the AP, it contends the channel over all of the operation channels, once it senses that any of the channels are available, it will send the uplink data packet with the receiver address as the MAC address of the associated AP or with destination address as the MAC address of the wireless TSN controller.

It should be noted that the sensor may turn on the Wi-Fi radio over all of the operating channels and start to contend the channel T time before the expected time that the uplink data packet is generated to mitigate the latency. To minimize the power consumption, the sensor will turn off the Wi-Fi radio over all the operating channels once it receives the ACK frame from AP.

All the coordinated APs(AP1-AP3):

In one or more embodiments, all the APs that hear the uplink data packet will start the packet reception. If the packet is received correctly, the receiver address is one of the APs those the AP is coordinated with or the destination address is the MAC address of the wireless TSN controller, it will forward that data packet to the wireless TSN controller and also feedback the ACK SIFS time after the reception of the uplink data packet.

It should be noted:

Activity over another channel:

Before the sensor receiving the ACK frame from any of the APs successfully, it will keep sensing the rest of the channels while it is transmitting the uplink data packet to the AP or is receiving the ACK frame from the APs. Once it senses that any one of the rest of the channels is available and the time left to the UL latency bound is long enough to send the uplink data packet, it will start to send the packet to the AP. In this way, the sensor is able to send an uplink data packet to the AP over multiple different channels independently. As a result, if there is co-channel interference over one of the operation channels, the sensor is still able to access another operation channel to send a data packet to the AP as shown in FIG. 14.

Ethernet TSN domain:

Wireless TSN controller:

With the received uplink packet sent from the sensor and forwarded by the AP, the wireless TSN controller will generate the downlink packet for the actuator and distribute to the AP associated with the actuator, such as AP1, and all of the APs those are coordinated with the AP1, such as AP2 and AP3.

Downlink Phase:

There are two different approaches to send the packet to the actuator with high reliability.

Approach1:

AP1:

AP1 is pre-selected by the wireless TSN controller as the associated AP of the actuator. It will follow the CCA rules defined in 802.11 specification to contend the channel over all of the operation channel TO time before the expected time that AP1 will receive the packet from the wireless TSN controller. The TO is pre-defined based on the traffic pattern of the packet from the wireless TSN controller. If any of the operation channels is available, it will send a multi-AP trigger frame to all of the coordinated APs that are pre-selected as the coordinated APs to serve the actuator.

All the Coordinated APs(AP1-AP3):

In one or more embodiments, all the coordinated APs that receive the multi-AP trigger frame will prepare the downlink data packet that is received from the wireless TSN controller with the transmission parameters indicated in the trigger frame and send it to the actuator SIFS time after the reception of the trigger frame.

Actuator(STA2):

in one or more embodiments, upon the reception of the multi-AP trigger frame from AP1, the actuator will wait for the downlink data packet and feedback the ACK frame SIFS time after the successful reception of the downlink data packet.

Note: To minimize the power consumption, the actuator will turn on the Wi-Fi radio over all of the operation channels only in a certain time period based on the traffic pattern of the downlink data packet from the AP, and turn off the Wi-Fi radio after the ACK frame transmission.

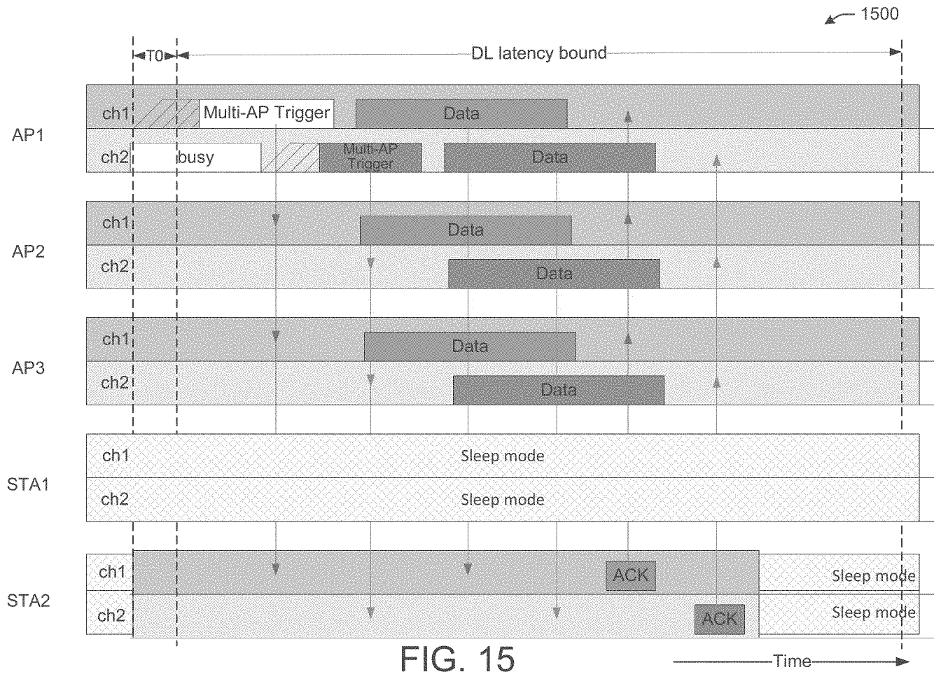

FIG. 15 depicts an illustrative schematic diagram 1500 for redundancy for WTSN, in accordance with one or more example embodiments of the present disclosure.

Referring to FIG. 15, there is shown a Downlink transmission with multiple AP/band/channel (Approach 1).

In one or more embodiments, all the APs may forward the ACK information to AP1 through backhaul to improve the reliability of the ACK frame.

In one embodiment, as in the uplink phase, multiple band/channel operation technology is also used in the downlink to improve the reliability. As shown in FIG. 15, before AP1 receive the ACK frame from the actuator successfully, it will keep sensing the other operation channels, such as ch2, in this example. If Ch2 is available and the time left to the DL latency bound is long enough to trigger all the coordinated APs to send the downlink data packet, it will start to send the multi-AP trigger frame to the coordinated APs over the available channel as shown in FIG. 15. In this way, the actuator is able to receive a downlink data packet from the AP over multiple different channels independently. As a result, if there is co-channel interference over one of the operation channels, the actuator is still able to receive a data packet from the AP over another operation channel.

Approach 2:

AP1:

In one or more embodiments, AP1 is pre-selected by the wireless TSN controller as the associated AP of the actuator. It will follow the CCA rules defined in 802.11 specification to contend the channel over all of the operation channel TO time before the expected time that AP1 will receive the packet from the wireless TSN controller. The TO is pre-defined based on the traffic pattern of the packet from the wireless TSN controller. If any of the operation channels is available, it will send the data packet to the actuator directly.

All the Coordinated APs (AP1-AP3):

In one or more embodiments, all the coordinated APs those receive a data packet from AP1 will 1) forward that data packet to the actuator or 2) prepare and send the downlink data packet with the transmission parameters used in the downlink data packet sent from the AP1 SIFS time after the end of the packet reception from AP1

Actuator (STA2):

In one or more embodiments, upon the reception of the data packet from AP1, the actuator will wait for the downlink data packet from other coordinated APs and feedback the ACK frame SIFS time after the successful reception of the downlink data packet. The first packet sent from the AP1 will indicate that there will be a following duplicate data packet sent SIFS time after the current packet.

Note: To minimize the power consumption, the actuator will turn on the Wi-Fi radio over all of the operation channels only in a certain time period based on the traffic pattern of the downlink data packet from the AP, and turn off the Wi-Fi radio after the ACK frame transmission.

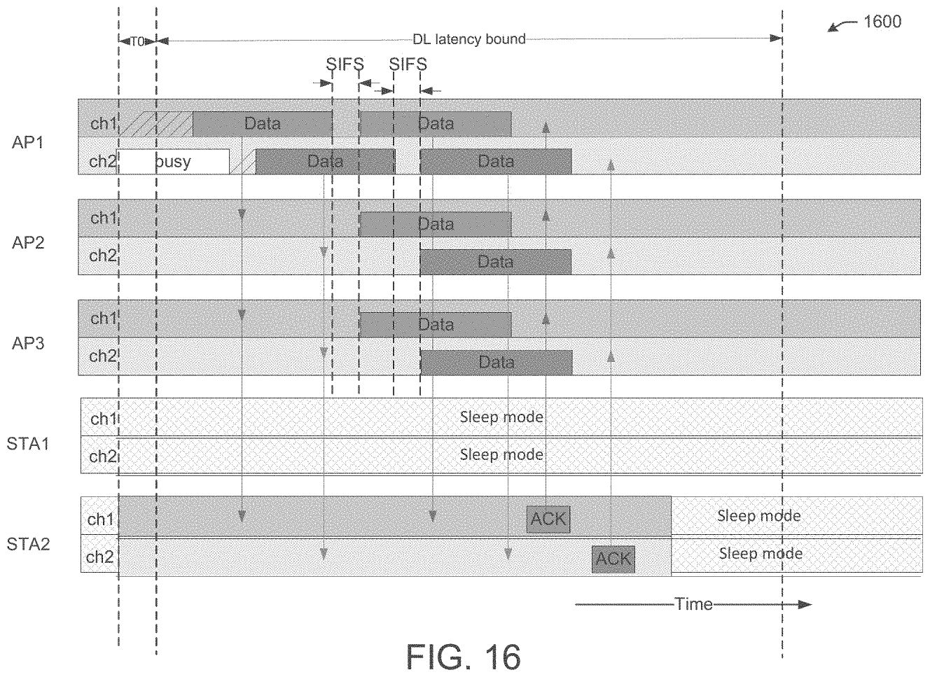

FIG. 16 depicts an illustrative schematic diagram 1600 for redundancy for WTSN, in accordance with one or more example embodiments of the present disclosure.

Referring to FIG. 16, there is shown Downlink transmission with multiple AP/band/channel (Approach 2).

In one or more embodiments, as in the uplink phase, multiple band/channel operation technology is also used in the downlink to improve the reliability. As shown in FIG. 16, before AP1 receive the ACK frame from the actuator successfully, it will keep sensing the other operation channels, such as ch2, in this example. If Ch2 is available and the time left to the DL latency bound is long enough to trigger all the coordinated APs to send the downlink data packet, it will start to send the data packet to the actuator over the available channel as shown in FIG. 16. In this way, the actuator is able to receive a downlink data packet from the AP over multiple different channels independently. As a result, if there is co-channel interference over one of the operation channels, the actuator is still able to receive a data packet from the AP over another operation channel.

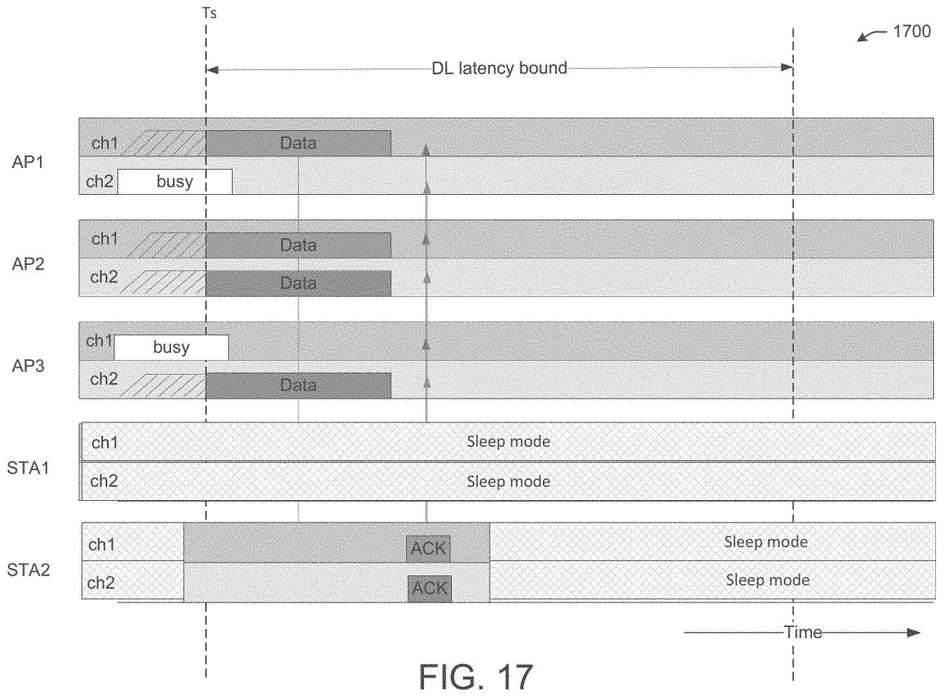

FIG. 17 depicts an illustrative schematic diagram 1700 for redundancy for WTSN, in accordance with one or more example embodiments of the present disclosure.

Referring to FIG. 17, there is shown a downlink transmission with multiple AP/band/channel (Approach 3).

Wireless TSN controller:

For each packet distributed from the wireless TSN controller, the wireless TSN controller will pre-define the start time to transmit the packet with the transmission parameter over the air to the actuator. All this information will be attached to the packet.

All the Coordinated APs (AP1-AP3)

All of the coordinated APs will prepare the downlink data packet with the transmission parameters defined by the wireless TSN controller. If the channel is idle for more than PIFS time before the pre-defined start time to send the packet, the coordinated AP will send the downlink data packet over the available channels.

As shown in FIGS. 17, AP1 and AP2 are sending the same data packet to STA 2 over ch1, AP2 and AP3 are sending the same data packet to STA2 over ch2.

Actuator (STA2)

In one or more embodiments, upon the reception of the downlink data packet, if the downlink packet is received correctly, the actuator will feedback the ACK frame SIFS time after the end of the downlink data packet reception.

Note: To minimize the power consumption, the actuator will turn on the Wi-Fi radio over all of the operation channels only in a certain time period based on the traffic pattern of the downlink data packet from the AP, and turn off the Wi-Fi radio after the ACK frame transmission.

It is understood that the above descriptions are for purposes of illustration and are not meant to be limiting.

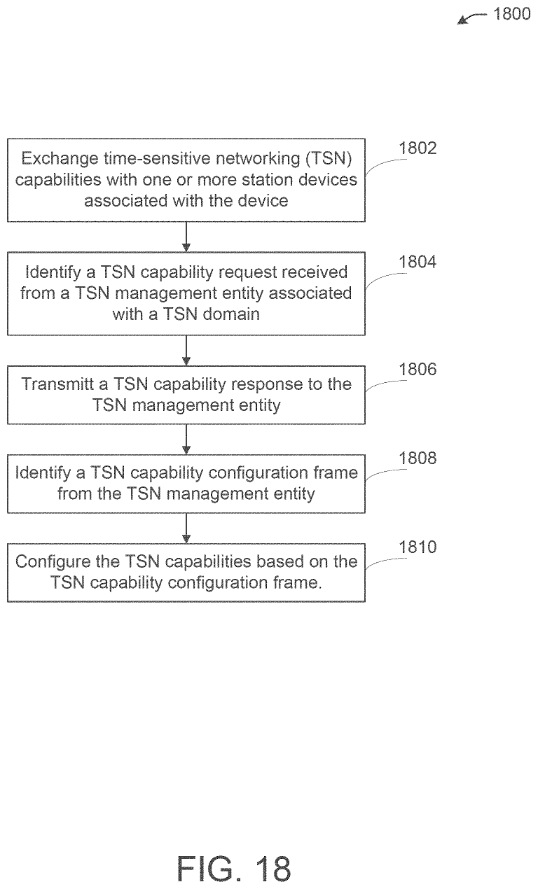

FIG. 18 illustrates a flow diagram of illustrative process 1800 for an implicit beamforming feedback system, in accordance with one or more example embodiments of the present disclosure.

At block 1802, a device (e.g., the AP 102 of FIG. 1) may exchange time-sensitive networking (TSN) capabilities with one or more station devices associated with the device. The device may set a TSN bit to 1 to indicate support for TSN traffic or 0 to indicate non-support for TSN traffic. The TSN bit may be included in a traffic stream (TS) information field.

At block 1804, the device may identify a TSN capability request received from a TSN management entity associated with a TSN domain. The TSN capability request received from the TSN management entity may be a discovery request to inquire about TSN capabilities from the device.

At block 1806, the device may transmit a TSN capability response to the TSN management entity. The TSN capability response comprises TSN capability information from the device. The TSN capability response comprises TSN capability information from the one or more station devices that are associated with the device.

At block 1808, the device may identify a TSN capability configuration frame from the TSN management entity. The TSN capability configuration frame may comprise specific configuration defined by the TSN management entity for the TSN domain. The device may manage wireless communication resources within a basic service set (BSS) of the device. The TSN management entity may be a centralized network configuration (CNC) responsible for performing admission control of time-sensitive networking (TSN) traffic. The device may identify a traffic specification (TSPEC) element received from at least one of the one or more station devices, wherein the TSPEC element comprises time-sensitive networking (TSN) traffic parameters. The device may confirm admission of a TSN traffic based on the TSPEC element.

At block 1810, the device may configure the TSN capabilities based on the TSN capability configuration frame.

It is understood that the above descriptions are for purposes of illustration and are not meant to be limiting.

FIG. 19 shows a functional diagram of an exemplary communication station 1900, in accordance with one or more example embodiments of the present disclosure. In one embodiment, FIG. 19 illustrates a functional block diagram of a communication station that may be suitable for use as an AP 102 (FIG. 1) or a user device 120 (FIG. 1) in accordance with some embodiments. The communication station 1900 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1900 may include communications circuitry 1902 and a transceiver 1910 for transmitting and receiving signals to and from other communication stations using one or more antennas 1901. The communications circuitry 1902 may include circuitry that can operate the physical layer (PHY) communications and/or medium access control (MAC) communications for controlling access to the wireless medium, and/or any other communications layers for transmitting and receiving signals. The communication station 1900 may also include processing circuitry 1906 and memory 1908 arranged to perform the operations described herein. In some embodiments, the communications circuitry 1902 and the processing circuitry 1906 may be configured to perform operations detailed in the above figures, diagrams, and flows.

In accordance with some embodiments, the communications circuitry 1902 may be arranged to contend for a wireless medium and configure frames or packets for communicating over the wireless medium. The communications circuitry 1902 may be arranged to transmit and receive signals. The communications circuitry 1902 may also include circuitry for modulation/demodulation, upconversion/downconversion, filtering, amplification, etc. In some embodiments, the processing circuitry 1906 of the communication station 1900 may include one or more processors. In other embodiments, two or more antennas 1901 may be coupled to the communications circuitry 1902 arranged for sending and receiving signals. The memory 1908 may store information for configuring the processing circuitry 1906 to perform operations for configuring and transmitting message frames and performing the various operations described herein. The memory 1908 may include any type of memory, including non-transitory memory, for storing information in a form readable by a machine (e.g., a computer). For example, the memory 1908 may include a computer-readable storage device, read-only memory (ROM), random-access memory (RAM), magnetic disk storage media, optical storage media, flash-memory devices and other storage devices and media.

In some embodiments, the communication station 1900 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1900 may include one or more antennas 1901. The antennas 1901 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1900 may include one or more of a keyboard, a display, a non-volatile memory port, multiple antennas, a graphics processor, an application processor, speakers, and other mobile device elements. The display may be an LCD screen including a touch screen.

Although the communication station 1900 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1900 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1900 may include one or more processors and may be configured with instructions stored on a computer-readable storage device.

FIG. 20 illustrates a block diagram of an example of a machine 2000 or system upon which any one or more of the techniques (e.g., methodologies) discussed herein may be performed. In other embodiments, the machine 2000 may operate as a standalone device or may be connected (e.g., networked) to other machines. In a networked deployment, the machine 2000 may operate in the capacity of a server machine, a client machine, or both in server-client network environments. In an example, the machine 2000 may act as a peer machine in peer-to-peer (P2P) (or other distributed) network environments. The machine 2000 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 2000 may include a hardware processor 2002 (e.g., a central processing unit (CPU), a graphics processing unit (GPU), a hardware processor core, or any combination thereof), a main memory 2004 and a static memory 2006, some or all of which may communicate with each other via an interlink (e.g., bus) 2008. The machine 2000 may further include a power management device 2032, a graphics display device 2010, an alphanumeric input device 2012 (e.g., a keyboard), and a user interface (UI) navigation device 2014 (e.g., a mouse). In an example, the graphics display device 2010, alphanumeric input device 2012, and UI navigation device 2014 may be a touch screen display. The machine 2000 may additionally include a storage device (i.e., drive unit) 2016, a signal generation device 2018 (e.g., a speaker), an enhanced TSN device 2019, a network interface device/transceiver 2020 coupled to antenna(s) 2030, and one or more sensors 2028, such as a global positioning system (GPS) sensor, a compass, an accelerometer, or other sensor. The machine 2000 may include an output controller 2034, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 2016 may include a machine readable medium 2022 on which is stored one or more sets of data structures or instructions 2024 (e.g., software) embodying or utilized by any one or more of the techniques or functions described herein. The instructions 2024 may also reside, completely or at least partially, within the main memory 2004, within the static memory 2006, or within the hardware processor 2002 during execution thereof by the machine 2000. In an example, one or any combination of the hardware processor 2002, the main memory 2004, the static memory 2006, or the storage device 2016 may constitute machine-readable media.

The enhanced TSN device 2019 may carry out or perform any of the operations and processes (e.g., process 1800) described and shown above.

It is understood that the above are only a subset of what the enhanced TSN device 2019 may be configured to perform and that other functions included throughout this disclosure may also be performed by the enhanced TSN device 2019.

While the machine-readable medium 2022 is illustrated as a single medium, the term “machine-readable medium” may include a single medium or multiple media (e.g., a centralized or distributed database, and/or associated caches and servers) configured to store the one or more instructions 2024.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 2000 and that cause the machine 2000 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 2024 may further be transmitted or received over a communications network 2026 using a transmission medium via the network interface device/transceiver 2020 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 2020 may include one or more physical jacks (e.g., Ethernet, coaxial, or phone jacks) or one or more antennas to connect to the communications network 2026. In an example, the network interface device/transceiver 2020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 2000 and includes digital or analog communications signals or other intangible media to facilitate communication of such software.

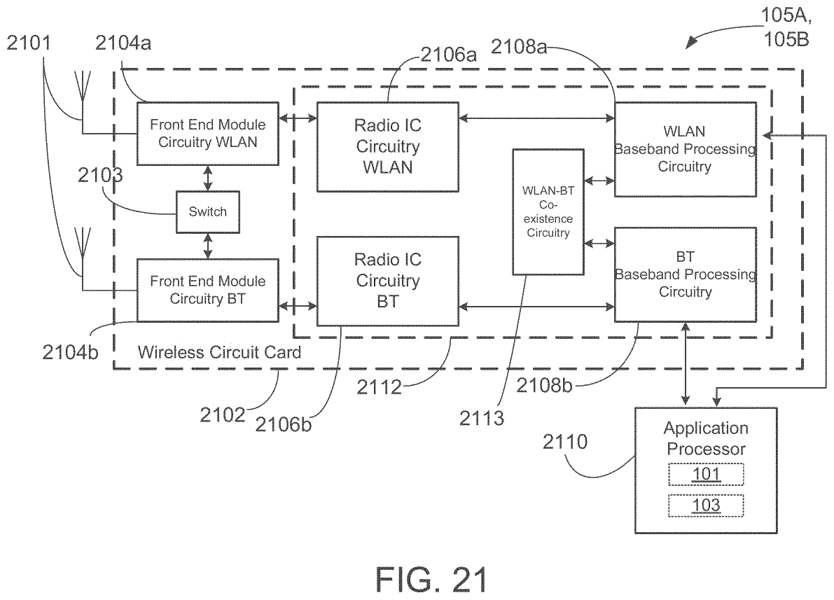

FIG. 21 is a block diagram of a radio architecture 105A, 105B in accordance with some embodiments that may be implemented in any one of the example AP 102 and/or the example user device 120 of FIG. 1. Radio architecture 105A, 105B may include radio front-end module (FEM) circuitry 2104a-b, radio IC circuitry 2106a-b and baseband processing circuitry 2108a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 2104a-b may include a WLAN or Wi-Fi FEM circuitry 2104a and a Bluetooth (BT) FEM circuitry 2104b. The WLAN FEM circuitry 2104a may include a receive signal path comprising circuitry configured to operate on WLAN RF signals received from one or more antennas 2101, to amplify the received signals and to provide the amplified versions of the received signals to the WLAN radio IC circuitry 2106a for further processing. The BT FEM circuitry 2104b may include a receive signal path which may include circuitry configured to operate on BT RF signals received from one or more antennas 2101, to amplify the received signals and to provide the amplified versions of the received signals to the BT radio IC circuitry 2106b for further processing. FEM circuitry 2104a may also include a transmit signal path which may include circuitry configured to amplify WLAN signals provided by the radio IC circuitry 2106a for wireless transmission by one or more of the antennas 2101. In addition, FEM circuitry 2104b may also include a transmit signal path which may include circuitry configured to amplify BT signals provided by the radio IC circuitry 2106b for wireless transmission by the one or more antennas. In the embodiment of FIG. 21, although FEM 2104a and FEM 2104b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 2106a-b as shown may include WLAN radio IC circuitry 2106a and BT radio IC circuitry 2106b. The WLAN radio IC circuitry 2106a may include a receive signal path which may include circuitry to down-convert WLAN RF signals received from the FEM circuitry 2104a and provide baseband signals to WLAN baseband processing circuitry 2108a. BT radio IC circuitry 2106b may in turn include a receive signal path which may include circuitry to down-convert BT RF signals received from the FEM circuitry 2104b and provide baseband signals to BT baseband processing circuitry 2108b. WLAN radio IC circuitry 2106a may also include a transmit signal path which may include circuitry to up-convert WLAN baseband signals provided by the WLAN baseband processing circuitry 2108a and provide WLAN RF output signals to the FEM circuitry 2104a for subsequent wireless transmission by the one or more antennas 2101. BT radio IC circuitry 2106b may also include a transmit signal path which may include circuitry to up-convert BT baseband signals provided by the BT baseband processing circuitry 2108b and provide BT RF output signals to the FEM circuitry 2104b for subsequent wireless transmission by the one or more antennas 2101. In the embodiment of FIG. 21, although radio IC circuitries 2106a and 2106b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 2108a-b may include a WLAN baseband processing circuitry 2108a and a BT baseband processing circuitry 2108b. The WLAN baseband processing circuitry 2108a may include a memory, such as, for example, a set of RAM arrays in a Fast Fourier Transform or Inverse Fast Fourier Transform block (not shown) of the WLAN baseband processing circuitry 2108a. Each of the WLAN baseband circuitry 2108a and the BT baseband circuitry 2108b may further include one or more processors and control logic to process the signals received from the corresponding WLAN or BT receive signal path of the radio IC circuitry 2106a-b, and to also generate corresponding WLAN or BT baseband signals for the transmit signal path of the radio IC circuitry 2106a-b. Each of the baseband processing circuitries 2108a and 2108b may further include physical layer (PHY) and medium access control layer (MAC) circuitry, and may further interface with a device for generation and processing of the baseband signals and for controlling operations of the radio IC circuitry 2106a-b.

Referring still to FIG. 21, according to the shown embodiment, WLAN-BT coexistence circuitry 2113 may include logic providing an interface between the WLAN baseband circuitry 2108a and the BT baseband circuitry 2108b to enable use cases requiring WLAN and BT coexistence. In addition, a switch 2103 may be provided between the WLAN FEM circuitry 2104a and the BT FEM circuitry 2104b to allow switching between the WLAN and BT radios according to application needs. In addition, although the antennas 2101 are depicted as being respectively connected to the WLAN FEM circuitry 2104a and the BT FEM circuitry 2104b, embodiments include within their scope the sharing of one or more antennas as between the WLAN and BT FEMs, or the provision of more than one antenna connected to each of FEM 2104a or 2104b.

In some embodiments, the front-end module circuitry 2104a-b, the radio IC circuitry 2106a-b, and baseband processing circuitry 2108a-b may be provided on a single radio card, such as wireless radio card 2102. In some other embodiments, the one or more antennas 2101, the FEM circuitry 2104a-b and the radio IC circuitry 2106a-b may be provided on a single radio card. In some other embodiments, the radio IC circuitry 2106a-b and the baseband processing circuitry 2108a-b may be provided on a single chip or integrated circuit (IC), such as IC 2112.

In some embodiments, the wireless radio card 2102 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 2108b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

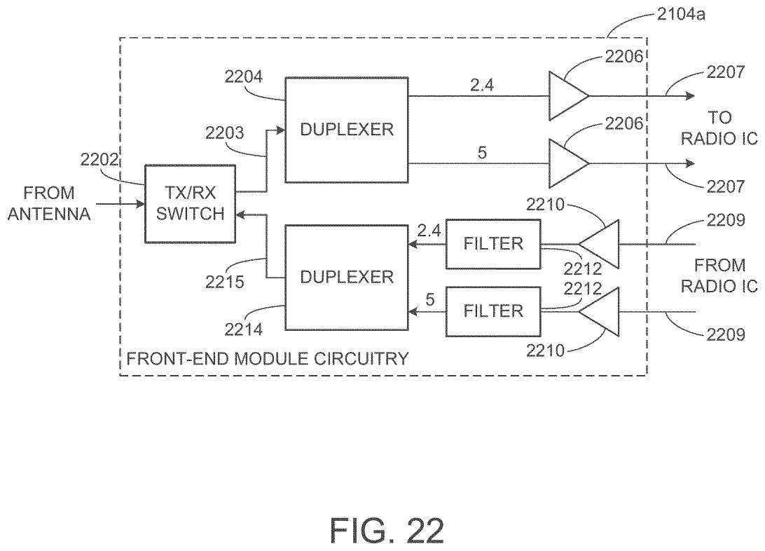

FIG. 22 illustrates WLAN FEM circuitry 2104a in accordance with some embodiments. Although the example of FIG. 22 is described in conjunction with the WLAN FEM circuitry 2104a, the example of FIG. 22 may be described in conjunction with the example BT FEM circuitry 2104b (FIG. 21), although other circuitry configurations may also be suitable.

In some embodiments, the FEM circuitry 2104a may include a TX/RX switch 2202 to switch between transmit mode and receive mode operation. The FEM circuitry 2104a may include a receive signal path and a transmit signal path. The receive signal path of the FEM circuitry 2104a may include a low-noise amplifier (LNA) 2206 to amplify received RF signals 2203 and provide the amplified received RF signals 2207 as an output (e.g., to the radio IC circuitry 2106a-b (FIG. 21)). The transmit signal path of the circuitry 2104a may include a power amplifier (PA) to amplify input RF signals 2209 (e.g., provided by the radio IC circuitry 2106a-b), and one or more filters 2212, such as band-pass filters (BPFs), low-pass filters (LPFs) or other types of filters, to generate RF signals 2215 for subsequent transmission (e.g., by one or more of the antennas 2101 (FIG. 21)) via an example duplexer 2214.

In some dual-mode embodiments for Wi-Fi communication, the FEM circuitry 2104a may be configured to operate in either the 2.4 GHz frequency spectrum or the 5 GHz frequency spectrum. In these embodiments, the receive signal path of the FEM circuitry 2104a may include a receive signal path duplexer 2204 to separate the signals from each spectrum as well as provide a separate LNA 2206 for each spectrum as shown. In these embodiments, the transmit signal path of the FEM circuitry 2104a may also include a power amplifier 2210 and a filter 2212, such as a BPF, an LPF or another type of filter for each frequency spectrum and a transmit signal path duplexer 2204 to provide the signals of one of the different spectrums onto a single transmit path for subsequent transmission by the one or more of the antennas 2101 (FIG. 21). In some embodiments, BT communications may utilize the 2.4 GHz signal paths and may utilize the same FEM circuitry 2104a as the one used for WLAN communications.

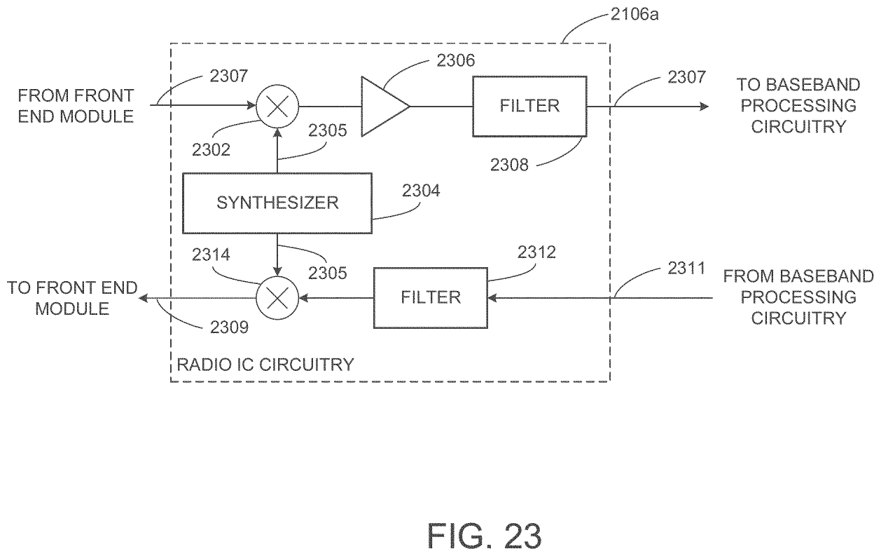

FIG. 23 illustrates radio IC circuitry 2106a in accordance with some embodiments. The radio IC circuitry 2106a is one example of circuitry that may be suitable for use as the WLAN or BT radio IC circuitry 2106a/2106b (FIG. 21), although other circuitry configurations may also be suitable. Alternatively, the example of FIG. 23 may be described in conjunction with the example BT radio IC circuitry 2106b.

In some embodiments, the radio IC circuitry 2106a may include a receive signal path and a transmit signal path. The receive signal path of the radio IC circuitry 2106a may include at least mixer circuitry 2302, such as, for example, down-conversion mixer circuitry, amplifier circuitry 2306 and filter circuitry 2308. The transmit signal path of the radio IC circuitry 2106a may include at least filter circuitry 2312 and mixer circuitry 2314, such as, for example, up-conversion mixer circuitry. Radio IC circuitry 2106a may also include synthesizer circuitry 2304 for synthesizing a frequency 2305 for use by the mixer circuitry 2302 and the mixer circuitry 2314. The mixer circuitry 2302 and/or 2314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 23 illustrates only a simplified version of a radio IC circuitry, and may include, although not shown, embodiments where each of the depicted circuitries may include more than one component. For instance, mixer circuitry 2314 may each include one or more mixers, and filter circuitries 2308 and/or 2312 may each include one or more filters, such as one or more BPFs and/or LPFs according to application needs. For example, when mixer circuitries are of the direct-conversion type, they may each include two or more mixers.

In some embodiments, mixer circuitry 2302 may be configured to down-convert RF signals 2207 received from the FEM circuitry 2104a-b (FIG. 21) based on the synthesized frequency 2305 provided by synthesizer circuitry 2304. The amplifier circuitry 2306 may be configured to amplify the down-converted signals and the filter circuitry 2308 may include an LPF configured to remove unwanted signals from the down-converted signals to generate output baseband signals 2307. Output baseband signals 2307 may be provided to the baseband processing circuitry 2108a-b (FIG. 21) for further processing. In some embodiments, the output baseband signals 2307 may be zero-frequency baseband signals, although this is not a requirement. In some embodiments, mixer circuitry 2302 may comprise passive mixers, although the scope of the embodiments is not limited in this respect.

In some embodiments, the mixer circuitry 2314 may be configured to up-convert input baseband signals 2311 based on the synthesized frequency 2305 provided by the synthesizer circuitry 2304 to generate RF output signals 2209 for the FEM circuitry 2104a-b. The baseband signals 2311 may be provided by the baseband processing circuitry 2108a-b and may be filtered by filter circuitry 2312. The filter circuitry 2312 may include an LPF or a BPF, although the scope of the embodiments is not limited in this respect.

In some embodiments, the mixer circuitry 2302 and the mixer circuitry 2314 may each include two or more mixers and may be arranged for quadrature down-conversion and/or up-conversion respectively with the help of synthesizer 2304. In some embodiments, the mixer circuitry 2302 and the mixer circuitry 2314 may each include two or more mixers each configured for image rejection (e.g., Hartley image rejection). In some embodiments, the mixer circuitry 2302 and the mixer circuitry 2314 may be arranged for direct down-conversion and/or direct up-conversion, respectively. In some embodiments, the mixer circuitry 2302 and the mixer circuitry 2314 may be configured for super-heterodyne operation, although this is not a requirement.

Mixer circuitry 2302 may comprise, according to one embodiment: quadrature passive mixers (e.g., for the in-phase (I) and quadrature phase (Q) paths). In such an embodiment, RF input signal 2207 from FIG. 23 may be down-converted to provide I and Q baseband output signals to be sent to the baseband processor

Quadrature passive mixers may be driven by zero and ninety-degree time varying LO switching signals provided by a quadrature circuitry which may be configured to receive a LO frequency (fLO) from a local oscillator or a synthesizer, such as LO frequency 2305 of synthesizer 2304 (FIG. 23). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree the synthesizer may generate time-varying switching signals, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 2207 (FIG. 22) may comprise a balanced signal, although the scope of the embodiments is not limited in this respect. The I and Q baseband output signals may be provided to low-noise amplifier, such as amplifier circuitry 2306 (FIG. 23) or to filter circuitry 2308 (FIG. 23).

In some embodiments, the output baseband signals 2307 and the input baseband signals 2311 may be analog baseband signals, although the scope of the embodiments is not limited in this respect. In some alternate embodiments, the output baseband signals 2307 and the input baseband signals 2311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 2304 may be a fractional-N synthesizer or a fractional N/N+1 synthesizer, although the scope of the embodiments is not limited in this respect as other types of frequency synthesizers may be suitable. For example, synthesizer circuitry 2304 may be a delta-sigma synthesizer, a frequency multiplier, or a synthesizer comprising a phase-locked loop with a frequency divider. According to some embodiments, the synthesizer circuitry 2304 may include digital synthesizer circuitry. An advantage of using a digital synthesizer circuitry is that, although it may still include some analog components, its footprint may be scaled down much more than the footprint of an analog synthesizer circuitry. In some embodiments, a voltage-controlled oscillator (VCO) may provide frequency input into synthesizer circuitry 2304, although that is not a requirement. A divider control input may further be provided by either the baseband processing circuitry 2108a-b (FIG. 21) depending on the desired output frequency 2305. In some embodiments, a divider control input (e.g., N) may be determined from a look-up table (e.g., within a Wi-Fi card) based on a channel number and a channel center frequency as determined or indicated by the example application processor 2110. The application processor 2110 may include, or otherwise be connected to, one of the example secure signal converter 101 or the example received signal converter 103 (e.g., depending on which device the example radio architecture is implemented in).

In some embodiments, synthesizer circuitry 2304 may be configured to generate a carrier frequency as the output frequency 2305, while in other embodiments, the output frequency 2305 may be a fraction of the carrier frequency (e.g., one-half the carrier frequency, one-third the carrier frequency). In some embodiments, the output frequency 2305 may be a LO frequency (fLO).

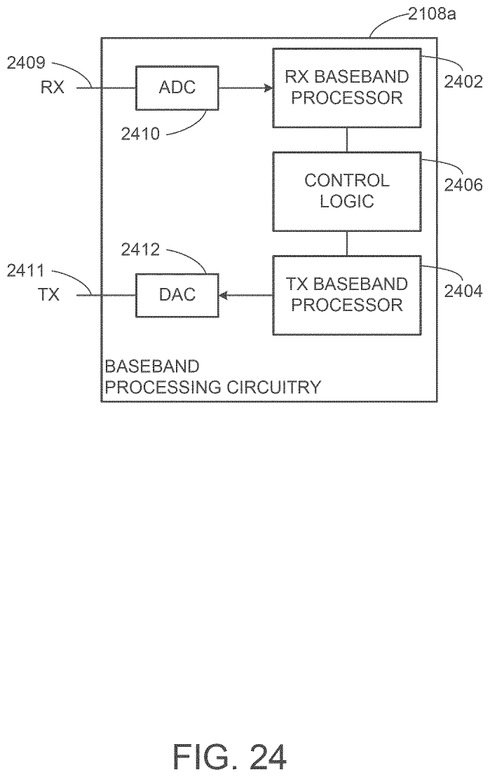

FIG. 24 illustrates a functional block diagram of baseband processing circuitry 2108a in accordance with some embodiments. The baseband processing circuitry 2108a is one example of circuitry that may be suitable for use as the baseband processing circuitry 2108a (FIG. 21), although other circuitry configurations may also be suitable. Alternatively, the example of FIG. 23 may be used to implement the example BT baseband processing circuitry 2108b of FIG. 21.

The baseband processing circuitry 2108a may include a receive baseband processor (RX BBP) 2402 for processing receive baseband signals 2309 provided by the radio IC circuitry 2106a-b (FIG. 21) and a transmit baseband processor (TX BBP) 2404 for generating transmit baseband signals 2311 for the radio IC circuitry 2106a-b. The baseband processing circuitry 2108a may also include control logic 2406 for coordinating the operations of the baseband processing circuitry 2108a.

In some embodiments (e.g., when analog baseband signals are exchanged between the baseband processing circuitry 2108a-b and the radio IC circuitry 2106a-b), the baseband processing circuitry 2108a may include ADC 2410 to convert analog baseband signals 2409 received from the radio IC circuitry 2106a-b to digital baseband signals for processing by the RX BBP 2402. In these embodiments, the baseband processing circuitry 2108a may also include DAC 2412 to convert digital baseband signals from the TX BBP 2404 to analog baseband signals 2411.

In some embodiments that communicate OFDM signals or OFDMA signals, such as through baseband processor 2108a, the transmit baseband processor 2404 may be configured to generate OFDM or OFDMA signals as appropriate for transmission by performing an inverse fast Fourier transform (IFFT). The receive baseband processor 2402 may be configured to process received OFDM signals or OFDMA signals by performing an FFT. In some embodiments, the receive baseband processor 2402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 21, in some embodiments, the antennas 2101 (FIG. 21) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 2101 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: exchange TSN capabilities with one or more station devices associated with the device; identify a TSN capability request received from a TSN management entity associated with a TSN domain; transmit a TSN capability response to the TSN management entity; and identify a TSN capability configuration frame from the TSN management entity; and configure the TSN capabilities based on the TSN capability configuration frame.

Example 2 may include the device of example 1 and/or some other example herein, wherein the TSN capability request received from the TSN management entity may be a discovery request to inquire about TSN capabilities from the device.

Example 3 may include the device of example 1 and/or some other example herein, wherein to cause to exchange the TSN capabilities comprises the processing circuitry being further configured to set a TSN bit to 1 to indicate support for TSN traffic or 0 to indicate non-support for TSN traffic.

Example 4 may include the device of example 3 and/or some other example herein, wherein the TSN bit may be included in a traffic stream (TS) information field.

Example 5 may include the device of example 1 and/or some other example herein, wherein the TSN capability response comprises TSN capability information from the device.

Example 6 may include the device of example 1 and/or some other example herein, wherein the TSN capability response comprises TSN capability information from the one or more station devices that are associated with the device.

Example 7 may include the device of example 1 and/or some other example herein, wherein the device may be an access point.

Example 8 may include the device of example 1 and/or some other example herein, wherein the TSN capability configuration frame may comprise specific configuration defined by the TSN management entity for the TSN domain.

Example 9 may include the device of example 1 and/or some other example herein, wherein to configure the TSN capabilities comprises the processing circuitry being further configured to manage wireless communication resources within a basic service set (BSS) of the device.

Example 10 may include the device of example 1 and/or some other example herein, wherein the TSN management entity may be a centralized network configuration (CNC) responsible for performing admission control of time-sensitive networking (TSN) traffic.

Example 11 may include the device of example 1 and/or some other example herein, wherein the processing circuitry may be further configured to: identify a traffic specification (TSPEC) element received from at least one of the one or more station devices, wherein the TSPEC element comprises time-sensitive networking (TSN) traffic parameters; and confirm admission of a TSN traffic based on the TSPEC element.

Example 12 may include a non-transitory computer-readable medium storing computer-executable instructions which when executed by one or more processors result in performing operations comprising: exchanging TSN capabilities with one or more station devices associated with the device; identifying a TSN capability request received from a TSN management entity associated with a TSN domain; transmitting a TSN capability response to the TSN management entity; and identifying a TSN capability configuration frame from the TSN management entity; and configuring the TSN capabilities based on the TSN capability configuration frame.

Example 13 may include the non-transitory computer-readable medium of example 1 and/or some other example herein, wherein the TSN capability request received from the TSN management entity may be a discovery request to inquire about TSN capabilities from the device.

Example 14 may include the non-transitory computer-readable medium of example 1 and/or some other example herein, wherein to cause to exchange the TSN capabilities further comprises setting a TSN bit to 1 to indicate support for TSN traffic or 0 to indicate non-support for TSN traffic.

Example 15 may include the non-transitory computer-readable medium of example 3 and/or some other example herein, wherein the TSN bit may be included in a traffic stream (TS) information field.

Example 16 may include the non-transitory computer-readable medium of example 1 and/or some other example herein, wherein the TSN capability response comprises TSN capability information from the device.

Example 17 may include the non-transitory computer-readable medium of example 1 and/or some other example herein, wherein the TSN capability response comprises TSN capability information from the one or more station devices that are associated with the device.

Example 18 may include the non-transitory computer-readable medium of example 1 and/or some other example herein, wherein the device may be an access point.

Example 19 may include the non-transitory computer-readable medium of example 1 and/or some other example herein, wherein the TSN capability configuration frame may comprise specific configuration defined by the TSN management entity for the TSN domain.

Example 20 may include the non-transitory computer-readable medium of example 1 and/or some other example herein, wherein to configure the TSN capabilities further comprises managing wireless communication resources within a basic service set (BSS) of the device.

Example 21 may include the non-transitory computer-readable medium of example 1 and/or some other example herein, wherein the TSN management entity may be a centralized network configuration (CNC) responsible for performing admission control of time-sensitive networking (TSN) traffic.

Example 22 may include the non-transitory computer-readable medium of example 1 and/or some other example herein, wherein the operations further comprise: identifying a traffic specification (TSPEC) element received from at least one of the one or more station devices, wherein the TSPEC element comprises time-sensitive networking (TSN) traffic parameters; and confirming admission of a TSN traffic based on the TSPEC element.

Example 23 may include a method comprising: exchanging TSN capabilities with one or more station devices associated with the device; identifying a TSN capability request received from a TSN management entity associated with a TSN domain; transmitting a TSN capability response to the TSN management entity; and identifying a TSN capability configuration frame from the TSN management entity; and configuring the TSN capabilities based on the TSN capability configuration frame.

Example 24 may include the method of example 1 and/or some other example herein, wherein the TSN capability request received from the TSN management entity may be a discovery request to inquire about TSN capabilities from the device.

Example 25 may include the method of example 1 and/or some other example herein, wherein to cause to exchange the TSN capabilities further comprises setting a TSN bit to 1 to indicate support for TSN traffic or 0 to indicate non-support for TSN traffic.

Example 26 may include the method of example 3 and/or some other example herein, wherein the TSN bit may be included in a traffic stream (TS) information field.

Example 27 may include the method of example 1 and/or some other example herein, wherein the TSN capability response comprises TSN capability information from the device.

Example 28 may include the method of example 1 and/or some other example herein, wherein the TSN capability response comprises TSN capability information from the one or more station devices that are associated with the device.

Example 29 may include the method of example 1 and/or some other example herein, wherein the device may be an access point.

Example 30 may include the method of example 1 and/or some other example herein, wherein the TSN capability configuration frame may comprise specific configuration defined by the TSN management entity for the TSN domain.

Example 31 may include the method of example 1 and/or some other example herein, wherein to configure the TSN capabilities further comprises managing wireless communication resources within a basic service set (BSS) of the device.

Example 32 may include the method of example 1 and/or some other example herein, wherein the TSN management entity may be a centralized network configuration (CNC) responsible for performing admission control of time-sensitive networking (TSN) traffic.

Example 33 may include the method of example 1 and/or some other example herein, further comprising: identifying a traffic specification (TSPEC) element received from at least one of the one or more station devices, wherein the TSPEC element comprises time-sensitive networking (TSN) traffic parameters; and confirming admission of a TSN traffic based on the TSPEC element.

Example 34 may include an apparatus comprising means for: exchanging TSN capabilities with one or more station devices associated with the device; identifying a TSN capability request received from a TSN management entity associated with a TSN domain; transmit a TSN capability response to the TSN management entity; and identifying a TSN capability configuration frame from the TSN management entity; and configuring the TSN capabilities based on the TSN capability configuration frame.

Example 35 may include the apparatus of example 1 and/or some other example herein, wherein the TSN capability request received from the TSN management entity may be a discovery request to inquire about TSN capabilities from the device.

Example 36 may include the apparatus of example 1 and/or some other example herein, wherein to cause to exchange the TSN capabilities further comprises setting a TSN bit to 1 to indicate support for TSN traffic or 0 to indicate non-support for TSN traffic.

Example 37 may include the apparatus of example 3 and/or some other example herein, wherein the TSN bit may be included in a traffic stream (TS) information field.

Example 38 may include the apparatus of example 1 and/or some other example herein, wherein the TSN capability response comprises TSN capability information from the device.

Example 39 may include the apparatus of example 1 and/or some other example herein, wherein the TSN capability response comprises TSN capability information from the one or more station devices that are associated with the device.

Example 40 may include the apparatus of example 1 and/or some other example herein, wherein the device may be an access point.

Example 41 may include the apparatus of example 1 and/or some other example herein, wherein the TSN capability configuration frame may comprise specific configuration defined by the TSN management entity for the TSN domain.

Example 42 may include the apparatus of example 1 and/or some other example herein, wherein to configure the TSN capabilities further comprises managing wireless communication resources within a basic service set (BSS) of the device.

Example 43 may include the apparatus of example 1 and/or some other example herein, wherein the TSN management entity may be a centralized network configuration (CNC) responsible for performing admission control of time-sensitive networking (TSN) traffic.

Example 44 may include the apparatus of example 1 and/or some other example herein, further comprising identifying a traffic specification (TSPEC) element received from at least one of the one or more station devices, wherein the TSPEC element comprises time-sensitive networking (TSN) traffic parameters; and confirming admission of a TSN traffic based on the TSPEC element.

Example 45 may include one or more non-transitory computer-readable media comprising instructions to cause an electronic device, upon execution of the instructions by one or more processors of the electronic device, to perform one or more elements of a method described in or related to any of examples 1-44, or any other method or process described herein.

Example 46 may include an apparatus comprising logic, modules, and/or circuitry to perform one or more elements of a method described in or related to any of examples 1-44, or any other method or process described herein.

Example 47 may include a method, technique, or process as described in or related to any of examples 1-44, or portions or parts thereof.

Example 48 may include an apparatus comprising: one or more processors and one or more computer readable media comprising instructions that, when executed by the one or more processors, cause the one or more processors to perform the method, techniques, or process as described in or related to any of examples 1-44, or portions thereof.

Example 49 may include a method of communicating in a wireless network as shown and described herein.

Example 49 may include a method of communicating in a wireless network as shown and described herein.

Example 50 may include a system for providing wireless communication as shown and described herein.

Example 51 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
exchange time-sensitive networking (TSN) capabilities with one or more station devices associated with the device;
identify a TSN capability request received from a TSN management entity associated with a TSN domain;
transmit a TSN capability response to the TSN management entity; and
identify a TSN capability configuration frame from the TSN management entity; and
configure the TSN capabilities based on the TSN capability configuration frame.

2. The device of claim 1, wherein the TSN capability request received from the TSN management entity is a discovery request to inquire about TSN capabilities from the device.

3. The device of claim 1, wherein to cause to exchange the TSN capabilities comprises the processing circuitry being further configured to set a TSN bit to 1 to indicate support for TSN traffic or 0 to indicate non-support for TSN traffic.

4. The device of claim 3, wherein the TSN bit is included in a traffic stream (TS) information field of a traffic specification (TSPEC) element with TSN traffic.

5. The device of claim 1, wherein the TSN capability response comprises TSN capability information from the device.

6. The device of claim 1, wherein the TSN capability response comprises TSN capability information from the one or more station devices that are associated with the device.

7. The device of claim 1, wherein the device is an access point.

8. The device of claim 1, wherein the TSN capability configuration frame may comprise specific configuration defined by the TSN management entity for the TSN domain.

9. The device of claim 1, wherein to configure the TSN capabilities comprises the processing circuitry being further configured to manage wireless communication resources within a basic service set (BSS) of the device.

10. The device of claim 1, wherein the TSN management entity is a centralized network configuration (CNC) responsible for performing admission control of time-sensitive networking (TSN) traffic.

11. The device of claim 1, wherein the processing circuitry is further configured to:
identify a traffic specification (TSPEC) element received from at least one of the one or more station devices, wherein the TSPEC element comprises time-sensitive networking (TSN) traffic parameters; and
confirm admission of a TSN traffic based on the TSPEC element.

12. A non-transitory computer-readable medium storing computer-executable instructions which when executed by one or more processors result in performing operations comprising:
exchanging time-sensitive networking (TSN) capabilities with one or more station devices associated with the device;
identifying a TSN capability request received from a TSN management entity associated with a TSN domain;
transmitting a TSN capability response to the TSN management entity; and
identifying a TSN capability configuration frame from the TSN management entity; and
configuring the TSN capabilities based on the TSN capability configuration frame.

13. The non-transitory computer-readable medium of claim 12, wherein the TSN capability request received from the TSN management entity is a discovery request to inquire about TSN capabilities from the device.

14. The non-transitory computer-readable medium of claim 12, wherein to cause to exchange the TSN capabilities further comprises setting a TSN bit to 1 to indicate support for TSN traffic or 0 to indicate non-support for TSN traffic.

15. The non-transitory computer-readable medium of claim 14, wherein the TSN bit is included in a traffic stream (TS) information field of a traffic specification (TSPEC) element with TSN traffic.

16. The non-transitory computer-readable medium of claim 12, wherein the TSN capability response comprises TSN capability information from the device.

17. The non-transitory computer-readable medium of claim 12, wherein the TSN capability response comprises TSN capability information from the one or more station devices that are associated with the device.

18. The non-transitory computer-readable medium of claim 12, wherein the device is an access point.

19. The non-transitory computer-readable medium of claim 12, wherein the TSN capability configuration frame may comprise specific configuration defined by the TSN management entity for the TSN domain.

20. A method comprising:
exchanging time-sensitive networking (TSN) capabilities with one or more station devices associated with the device;
identifying a TSN capability request received from a TSN management entity associated with a TSN domain;
transmitting a TSN capability response to the TSN management entity; and
identifying a TSN capability configuration frame from the TSN management entity; and
configuring the TSN capabilities based on the TSN capability configuration frame.
